(19) United States
(12) Patent Application Publication
(10) Pub. No.: US 2006/0173601 A1
(43) Pub. Date: Aug. 3, 2006

(54) Computer system and method for controlling, particularly for executing the coordinated drive train control of a motor vehicle

(76) Inventors: Dirk Bassiere, Ludwigsburg (DE); Frank Bickendorf, Ditzingen (DE); Rasmus Frei, Bietigheim-Bissingen (DE)

Correspondence Address: KENYON & KENYON LLP, ONE BROADWAY, NEW YORK, NY, 10004, US

(21) Appl. No.: 10/523,546

(22) PCT Filed: Jul. 29, 2003
(86) PCT No.: PCT/DE03/02541

§ 371 Date: Dec. 30, 2005

(30) Foreign Application Priority Data
Jul. 29, 2002 (DE) 102 34 635.6
Jul. 29, 2003 (DE) 103 34 536.1

(51) Int. Cl. G06F 17/00

(52) U.S. Cl. 701/53; 701/36

(57) ABSTRACT

A multi-layered module-type software layout known from the related art has been further developed for vehicles, and in addition, definite procedures are given for putting it into practical use. According to the present invention, to do this, a computer system is described having a software architecture (FIG. 4) that includes practical function assignments and interfaces having exchangeable modular plug-ins. With the aid of a prioritization method according to the present invention, these plug-ins may be polled independently of the number and functioning of the requesting systems for flexibilization. A method according to the present invention for powertrain control of a motor vehicle is divided into 5 phases from the characterization of environmental influences to the approach to the optimal operating point. In a computer system according to the present invention, having an object-oriented software system, this method may also be applied.

The present invention relates to a computer system and a method for controlling, especially for coordinating, the powertrain control of a motor vehicle.

In automotive technology, originally electronics was used only in the form of individual, electronified components, these components operating in an isolated manner, and independently of one another. Thereafter, these components were increasingly integrated into systems. Examples for this are electronic engine control systems, braking regulation systems or driver information systems. Currently, one may observe a trend towards the networking of all vehicle systems with one another, and increasingly also with the vehicle's surroundings.

Now, this recognizable growing together of the systems brings with it considerable technical and organizational challenges:
new vehicle functions are frequently implementable and effectively usable only in conjunction with different subsystems,
this makes necessary a functional integration of subsystems from even different suppliers,
the valence and the character of vehicles are determined increasingly by complex software functions,
mastering the growing systems complexity is becoming competitively decisive for the vehicle manufacturer and supplier, with respect to speed, cost and quality.

### BACKGROUND INFORMATION

From DE 199 16 637 C1, a method is known for controlling the powertrain of a motor vehicle and a drive train control of a motor vehicle. The aim, in this context, even for motor vehicles having an automatic transmission, is to support the deceleration by the powertrain of the motor vehicle by the operation of the foot brake by the driver. A central control unit evaluates a braking torque command or a vehicle deceleration command of the driver, which, for example, is additionally a function of the operating parameters driver type, load state and road conditions (for instance, winter mode), which is manifested by operating the accelerator. Based on this ascertained braking torque, an engine drag torque setpoint value is determined. The transmission ratio of the automatic transmission is automatically determined as a function of the engine drag torque setpoint value, in the light of a downshifting characteristics map. Disadvantageously, all processes are controlled by a central control unit, so that adjusting of the central control unit to various vehicle types, or the introduction of new control components is not possible.

From DE 199 40 703 C1, a method and a device are known for engine control and transmission control in a motor vehicle having an internal combustion engine that is controlled by an engine control, and a stage automatic transmission that is controlled by a transmission control. In this context, the wheel drive torque (wheel torque), even in the case of a step automatic transmission, at constant accelerator setting, is changed constantly (continually) as plotted against the vehicle speed. The wheel torque has, as a function of the vehicle speed, a declining, hyperbola-like shape, in which, irrespective of the shifting processes, no discontinuity occurs in the wheel torque curve. From a wheel torque desired by the driver, the totality of torque coordinator, engine control and transmission control calculates a setpoint engine torque, and carries it out within the scope of physical boundaries. Outside of the shifting procedure of the step automatic transmission, this is achieved in that, at least as a function of the transmission ratio and the specified transmission drive torque, a torque demand acting on the charge and/or a torque demand acting on the ignition are calculated. With that, a certain engine torque is to be attained, which, while shifting in between the known transmission ratio, yields exactly the specified transmission drive torque. During the shifting process of the step automatic transmission, the implementation of the transmission drive torque takes place essentially via a friction element provided in the step automatic transmission. A certain torque is transmitted corresponding to the controlled variable selected for the friction element. That is why the controlled variable is set during the shifting process in particular in such a way that the desired transmission output torque is achieved according to a selectable transition function. What is disadvantageous here is that the wheel torque is a function exclusively of the accelerator swetting, and no other factors, such as driver type or wheel slip, are taken into consideration. The method and the device are not flexible, because their are integrated into an engine control and transmission control of a vehicle, and thus a transfer to other vehicle types and control unit configurations is not possible. Moreover, new control functions are also not able to be integrated.

From DE 198 38 333 A1 of the Applicant, a computer system is known having at least one processor and at least one memory for controlling a drive unit. It is the aim to state a control structure of the overall vehicle with the aid of which the drive train and especially the drive unit may be linked to externally lying components. Drive train and drive unit are merged into an overall vehicle concept in an engine management. The vehicle is regarded as an overall system, made up of functional units as a first component. The overall system, made up of functional units, is subdivided into various predefinable components, such as vehicle motion and drive coordinator. The drive unit, in this context, is specified as a component. The drive unit is controlled as a function of the specified components and/or the data exchanged at the interfaces between the components. Because of this composite system, individual elements or functional units can no longer be regarded separately, but merged into the overall concept. In a drive control or an engine control, for example, not only torque demands or power demands or rotary speed specifications of the vehicle motion, such as steering, brake or driving dynamics regulation have to be taken into consideration, but also power demands or torque demands and/or rotary speed data on all accessories and actuators. However, beyond that, there is also the possibility of carrying out a drive control adapted to the respective circumstances, by access to data and information of other functional units and systems, such as surroundings variables, driving state variables, vehicle variables and user variables. However, in this case it is disadvantageous that it is not possible to exchange individual functional units in module fashion, i.e. a flexible, module-type system construction is not present. Furthermore, inclusive statements on the concrete implementation of the specification of the aim are also not made.

From EP 0 883 510 B1 a powertrain control for a motor vehicle is known which includes a wheel torque calculating circuit, by which the setting of the accelerator is interpreted as a wheel torque or transmission output torque commanded by the driver, and is used for calculating setpoint values for the torque to be developed by the drive train, and which has a control circuit that is furnished with a fuzzy system, in which the desired wheel torque is evaluated together with operating parameters of the motor vehicle and with environmental parameters, by which, in the light of a central driving strategy selection circuit, the operating mode of the drive train is adjusted to predefined criteria, at any driving manner of the driver and driving situations of the motor vehicle, and which is connected to an engine performance actuator to which it emits an output signal, by which the setpoint wheel torque to be supplied by the wheels to the roadway is determined. A strategy is determined centrally for the engine control, the engine performance actuator and the drive control in such a way that the discharge of polluting agents is minimized. The central strategy may also have as a purpose a driving performance-oriented mode of the motor vehicle. All decentralized functional units are set in this strategy in such a way that a best possible acceleration and a quick response of the drive to the driver's command are available. Such a mode is necessary for a sporty manner of driving and for uphill driving The control takes place via a control circuit, the data exchange being carried out via a rapid serial bus communication, such as a CAN bus.

This has the disadvantage that, based on the overall configuration, there is only a very slight flexibility with respect to different vehicle configurations and control unit configurations and reusability of developed software components, because all the components are adapted to the central control circuit.

In motor vehicles, for different components in the powertrain, such as engine and transmission, interfaces are agreed upon for communications via which the demands are able to be transmitted, so that they may be carried out by the receiving component (in the motor vehicle field, a widespread technical interface for control unit networking is, for example, the CAN bus).

Besides the accelerator and the brake pedal there are many additional demand setters that can make demands on the powertrain. Typical examples for this are convenience systems, such as the vehicle speed controller, or safety systems, such as the ASR and ESP. In this context, a large portion of development and computing capacity is disadvantageously used to decide, corresponding to the current driving situation, at what point which system is actually permitted actively to specify or influence the operating point of the drive train.

It is known that, for controlling operating sequences of a vehicle, one may use embedded software solutions, building up on a real-time operating system as a standard operating system, e.g. ERCOS or OSEK or rather OSEKJVDX. In this context, application-specific functions, basic system functions, core functions as well as the corresponding driver software, that is, the specific base functions, are interwoven, on the one hand, with the different operating functions and suboperating functionalities on the other hand, which determine the actual operating behavior of the vehicle. Necessary or desired changes in functions, or the retrospective fitting in of functions permit creating very complex systems developments in the case of such interwoven software solutions, particularly of the interfaces.

From DE 100 44 319 A1 of the Applicant, the abstract idea is already known that one may achieve an optimization by the clear separation of operating functions and base functions and the introduction of a system layer or intermediate layer having an open interface function. In this context, one starts from an electronic system for a vehicle or from a system layer of the electronic system, the electronic system including first components for carrying out control tasks during operating sequences of the vehicle, and second components which coordinate cooperation of the first components for carrying out the control tasks. In this context, the components execute the control tasks by using operating functions and basic functions. Advantageously, the system is constructed in such a way that the basic functions and the operating functions or partial operating functionalities (designated as operating submodules or plug-ins) are clearly separated from one another, the basic functions being combined in a base layer. The system layer is then expediently superimposed on the base layer, which contains the basic functions. The system layer or intermediate layer, in this context, includes at least two of the second components that coordinate the cooperation of the control components. In this context, at least one open interface to the operating functions is provided, in or for the system layer, whereby the system layer connects the basic functions to any desired operating functions in such a way that the operating functions are modularly linked and/or used, or are able to be linked modularly to the electronic system. Thereby the operating functions or the operating sub-modules become able to be modularly linked to the electronic system, reusable, and exchangeable or changeable at any time. Because of the system layer, a defined interface is determined, so as to make possible, within the scope of the control unit software, a variant formation for any operating functions as well as broadenings or changes of the functionality, especially by operating sub-modules, so-called plug ins. Thereby, in one embodiment, a system that is already in mass production or in use or operation, may at any time be further refined, changed and/or broadened by the addition of new operating functions. With this, in a meaningful way, control tasks or specific performance features of an electronic system may be flexibly and individually designed, developed and implemented. Besides that, in addition, the monitoring functions with respect to the operating functions and/or the operating sub-modules may be linked to the system layer. Because of this modularization of the software functionalities and the monitoring functionalities, the possibility arises, for example, of linking software set up by third parties to the electronic system with little expenditure. This also permits constituting specific variants exclusively within the operating functions or the operating sub-modules, while the system layer may be designed independent of the application. What makes this disadvantageous is that only formal requirements are made, and concrete procedures, as regards content, are not given.

### SUMMARY OF THE INVENTION

Starting from the described related art, the intention is to create a computer system and a method for control, especially for the coordinated control of the powertrain of motor vehicles, which have available definite procedures with respect to content.

The present invention proposes a computer system having the features of claims 1 and 25, as well as a method having the features of claims 8, 12 and 19. Advantageous refinements of the present invention are the subject matter of the dependent claims.

In this context, according to the present invention, in particular,
requirements of various systems are centrally introduced in a uniform manner, based on system reference variables (essentially the transmission output torque),
the most varied methods are introduced for ascertaining suitable operating points of the powertrain,
the requirements and the methods are prioritized, suitable for the situation, corresponding to the current driving situation by an abstract prioritization method, so that the correct requirement is taken into consideration and the optimal method is used for the operating point selection,
the requirements are recalculated corresponding to the drive train topology of the respective vehicle, and specifications are made on drive train components, the interfaces to the components being specified as abstractly as possible on a physical basis, in order to exclude as far as possible dependencies, for instance, on various engine types (Diesel and gasoline),
the possibility is offered of combining the ascertainment of requirements and methods for calculating optimal operating points in plug-ins, in order thus to create separable systems in the sense of salable products.

For the functionable putting into use of a module-type system construction, it is required that one state a software architecture in which clear functions are assigned to the individual elements or components. By the abstract concept of architecture, both the systematology of the structuring of a complex system composite and its practical putting into use are understood. For this reason, according to the present invention, a computer system is described having at least one processor and at least one memory for control, especially for powertrain control for a motor vehicle, which has available to it an appropriate software architecture. This is made up of the following elements or components: an operating system and specific services having a operating system and specific services as a basis for all other elements and applications, a basic functionality for adapting universal requirements, basic functions of a control unit, such as of the control of actuators of an internal combustion engine, being managed in the basic functionality, a “layer” for coordinating tasks for basic functionalities of the basic functionality, and for the linking of plug-ins and at least one plug-in for putting into use specific tasks or functions which go beyond the base functionality of the basic functionality and are coordinated by the layer.

In this context, advantageously, the plug-ins may be exchanged in module fashion in the computer system, whereby the computer system may be adapted in a flexible manner to different manufacturers' wishes and customer wishes, and functions are simple to implement. Therefore, the customer functions implemented in the plug-ins may be transferred in a simple and advantageous manner to various vehicle types or different engines, without having to change these. The adaptation to a changed vehicle configuration is undertaken by adaptations, for example, in the basic functionality (e.g. Diesel engine instead of gasoline engine).

Furthermore, new individual functions may be simply fit into the computer system by this module type of construction. Because of this, software sharing, for example, is also possible.

Besides, advantageously, in the software architecture open interfaces, which may be accessed from outside, and encapsulated interfaces, which are not open to the outside, are also integrated.

Possibilities for plug-ins for putting into use, for example, various characteristic properties of vehicles include, for example, an ACC request (adaptive cruise control request) for adapting the speed or the clearance of the vehicle, a driver's demand (comfort or sport) for rating and interpreting the accelerator, driveability for fixing a global optimization criterion, such as driving comfort or sport, as well as shift strategy (comfort or sport), which, from the setpoint value for the torque at the transmission output and the vehicle speed determine the setpoint value for the transmission ratio and the engine torque.

In the layer, for instance, the coordinators vehicle coordinator, vehicle motion coordinator and power train coordinator are integrated. Each coordinator should be able to communicate with the plug-ins, i.e. should be connected to the plug-ins via interfaces. Furthermore, the layer should be connected via interfaces to communication with the basic functionality, which contains base functions that act like sensors or actuators, the engine management, for example, acting as a torque setter, the transmission management converting a transmission ratio, the brake management setting a requested negative setpoint acceleration.

Requirements of various systems are centrally introduced in a uniform manner, based on system reference variables, e.g. the transmission output torque. Thus, the computer system according to the present invention permits a vehicle to adapt flexibly to various requirements, by the simple exchange or the addition of functions that are contained in plug-ins. Thereby, automobile manufacturers are able to introduce brand differentiation based on software, because vehicles having different properties are available based solely on different software components. Furthermore, costs may also be reduced to a substantial degree, because, to adjust to new functions, the entire computer system does not have to be exchanged, but the properties may be changed simply by the cost-effective exchange of individual plug-ins.

In order to achieve in a simple way the desired simple exchangeability of functions in the plug-ins, in the described computer system according to the present invention, it is necessary that the remaining components of the software architecture are able to access the plug-ins independently of the number and the manner of functioning of the plug-ins. Only in that way may the plug-ins be exchanged at will. A prioritization method, according to the present invention, of information sensors, such as plug-ins, for controlling, especially coordinating powertrain control for a motor vehicle, realizes this objective. The prioritization method may, for example, may be used in the just described computer system. In the plug-ins or requesters, a request command is included as a function of the current driving situation, there not having to be included, however, a request command for each particular driving situation in the corresponding plug-in or requester. The requesters or plug-ins are sorted according to the degree of their priority in rising or declining order, these priorities being determined as a function of global optimization criteria, such as an economic adjustment, a sport adjustment or a winter detection. In this appropriately sorted list having requesters or plug-ins, the individual requesters are processed sequentially beginning with the requesters having the highest priority, that is, a poll is made as to whether a request command is present in the requester or the plug-in. As soon as a requester includes a request command, the processing is discontinued, and the request command included in this requester is selected, preferably stored, and passed on. Each requester in the sorted lists may be uniquely designated by an identity (ID), preferably as a number, and its position in the list.

In an additional prioritization method, according to the present invention, of information sensors, such as plug-ins, in a list having requesters or plug-ins, all requesters are processed in any desired sequence, this list not being sorted by priorities and the processing being able to take place in this instance also sequentially, for example. Subsequently to this, the request command in the list of requesters is ascertained along with the maximal (minimal) request command or the average request command is ascertained. This maximal (minimal) request command is then stored and passed on.

In order to ascertain the maximal (minimal) request command, the scheme described below is generally used. The requesters or plug-ins included in the non-sorted list are polled in any desired sequence. The first polled request command, that originates with a plug-in that includes a request command, is first stored temporarily. Each additional polled request command is compared to the temporarily stored request command, to see whether it is greater (less) than the temporarily stored request command. If a polled request command is greater (less) than the temporarily stored request command, this polled request command is temporarily stored and the preceding request command is deleted, i.e. the value stored up to that point is overwritten by the currently polled value, and in the other case no storing taking place, i.e. the request command temporarily stored up to that point remains stored. After polling all requesters, the maximal (minimal) request command is temporarily stored and may be passed on.

In this connection, in one variant, with respect to certain requesters, such as requesters that control the engine and the brake, using one certain request command, for instance, a braking intervention, the minimal (maximal) request command, such as the minimal propulsion command, may be selected, and otherwise the maximal (minimal) request command.

In one further variant of the just described prioritization method, after maximal (minimal) selection it is also possible that individual requesters or plug-ins have the effect that certain other requesters are not taken into consideration in the ascertainment of the maximal (minimal) requeste command. For example, a requester accelerator may have the effect that all other requesters, which effect braking/deceleration, are not taken into consideration.

Each requester or a plug-in is clearly marked by an identity (ID), preferably a number, for processing. That means that the position in the list is not meaningful. Even in this prioritization method there are various lists for adapting to global optimization criteria, such as economic adjustment, sport adjustment or winter detection, it being only relevant here, however, which requesters are in the list.

The two prioritization methods just described may also be combined with each other, preferably the prioritization method first described being used first and, if this does not lead to a result, the second prioritization method is applied. The first prioritization method does not deliver a request command if, in the appropriate list, a request command is not included in any of the requesters or plug-ins.

For the coordinated powertrain control of a motor vehicle it is necessary to subdivide the complicated process of this control into individual method steps which can be carried out by an appropriate computer system, or rather, the software. A method according to the present invention for coordinating the powertrain control of a motor vehicle has essentially the following steps or phases:
1. characterizing the environmental influences,
2. determining a global optimization criterion, such as sporting, economical or wear-preventive,
3. interpretating driver command,
4. determing the optimal operating point and
5. approaching the optimal operating point.

For the characterization of the environmental influence in the first step, current environmental data are prepared and standardized, if necessary, such as vehicle variables (speed, transverse acceleration), powertrain condition (power transmission and trailing throttle/traction), driver type detection (sporting or economical, by derivation from his driving behavior) and driving situation detection (hill, curve, winter, city, expressway). In the 2nd step a global optimization criterion is determined. In the driver command interpretation as the 3rd method step, a specification is derived for the longitudinal motion of the vehicle, such as from the accelerator interpretation according to acceleration/deceleration and/or the specifications of a driving speed regulator or an ACC, a system reference variable transmission output torque being subdivided into a variable transmission output torque for the powertrain and a variable vehicle deceleration for the brake. For the determination of the optimal operating point in the 4th method step for a transmission output torque, a certain engine torque and a transmission ratio are ascertained. The approach to the optimal operating point in the 5th and last method step is carried out within a certain time, that is, the approach takes place not abruptly or as quickly as possible, but is adjusted to certain criteria, such as driveability, comfort, safety and engine protection. In these phases, preferably the individual tasks of the phases or steps are processed by coordinators in a layer of a computer system according to the present invention. The contents of the phases are transmitted or made available by the plug-ins via interfaces, the selection of the plug-ins preferably taking place according to one of the prioritization methods according to the present invention.

In order to create a computer system for the control, it is expedient to have available an object-oriented software system. An object-oriented software system is structured with the purpose in mind of assigning the software to individual parts or components of the object to be controlled or to state variables or even tasks. In a motor vehicle, these are, for instance, the vehicle, the vehicle motion, the engine, the transmission or the driver type, as well as the vehicle variable. The computer system according to the present invention, having at least one processor/memory and having an object oriented software system, is made up essentially of the following object-oriented components: Vehicle motion (VM), powertrain (PT), vehicle coordinator (VC), information providers, such as environmental data (ED), driving condition data (DD), vehicle data (VD) and user data (UD). In the information providers, current state variables are stored. These object-oriented components are connected to interfaces towards outside and inside (interface in and out) and a criteria coordinator (CC) for polling plug-ins for communication with interfaces. Component vehicle motion has additionally, for example, the components traction system and driving stability system (ESP), vehicle motion coordinator (VMC) and propulsion/brake (PrB). This component propulsion/brake additionally has, for instance, the components propulsion system (PrSy), brake system (BrSy) and a propulsion and brakes coordinator (PrBC) having a component acceleration request manager (AccRM). In response to a negative acceleration (deceleration), the acceleration request manager decides which proportion will be assumed by the engine and which part by the brakes. Component powertrain has, for example, the components powertrain coordinator (PTC), engine (Eng), transmission (Tra) and the information provider has powertrain state variables or powertrain data (PD). The criteria coordinator is able to communicate with an application programming interface (API). Thus, according to the present invention, an object-oriented software system is made available which is adapted optimally to a module-like system configuration.

In an additional refinement, the method according to the present invention, described above, is carried out using 5 phases and the computer system according to the present invention, having an object-oriented software system. It has the following steps:
For the characterization of the environmental influences, the current environmental data or state variables are assigned to the information providers, which all other components may access, with the exception of the drive state variables, which only the powertrain can access.
In the 2^{nd} method step, the vehicle coordinator controls the determination of a global optimization criterion, which polls suggestions via the criteria coordinator of selected plug-ins.
In the next method step, the propulsion and brake coordinator control the driving command interpretation which, in collaboration with selected plug-ins, ascertains, via the criteria coordinator, the specifications for brakes and powertrain, preferably the vehicle motion coordinator coordinating these specifications with the traction and driving stability system and passing on these specifications to the powertrain and brake system; a driving acceleration, for example, being recalculated to a transmission output torque via the application interface, and passed on to the powertrain.
In the 4th method step the powertrain coordinator selects plug-ins for determining the optimal operating point via the criteria coordinator, and the powertrain coordinator communicates with the plug-ins via the criteria coordinator.
in the 5^{th} and last step, based on the same procedure, the approach—meaning the transition from the current to the new operating point—to the newly selected operating point is determined.

In this method, the selection of the plug-ins is preferably made using the above-described prioritization method according to the present invention. Thus, this method permits executing the method, according to the present invention, for controlling a vehicle, with the aid of an object-oriented software system.

Parts of the present invention are also represented by the computer programs having program code means or computer program products having program code means, which are stored on a readable data carrier, in order to carry out one of the methods according to the present invention, provided the computer program is run on a computer or an appropriate calculating unit.

### BRIEF DESCRIPTION OF THE DRAWINGS

The present invention is described below as an example. The figures show:

FIG. 1 a schematic representation of an “intelligent” vehicle of the future,

FIG. 2 a schematicized development process of a module type of system construction,

FIG. 3 a structured functional architecture aligned to the vehicle topology,

FIG. 4 a schematicized outline of a software architecture of the module type of system construction, according to the present invention,

FIG. 5 a schematicized exemplary representation in concrete terms of the system architecture of the module type of system construction, according to the present invention,

FIG. 6 a schematicized view of the symbolic layout of a motor vehicle as an experimental vehicle,

FIG. 7 a software architecture according to the present invention having plug-in design, in a layer view,

FIG. 8 a schematicized internal construction of a vehicle motion, according to the present invention,

FIG. 9 a graphic representation of a linear prioritization (first stage) according to the present invention and a maximal selection (second stage) according to the present invention,

FIG. 10 a flow chart according to the present invention of a prioritization method as a combination of linear prioritization (first stage) and maximal selection (second stage),

FIG. 11 a method according to the present invention for coordinated powertrain control in a representation between plug-ins and drive train components,

FIG. 12 a software structure according to the present invention for the method of the invention for coordinated powertrain control,

FIG. 13 an object-oriented software system according to the present invention for coordinated powertrain control,

FIG. 14 a schematicized representation of the phases of the method according to the present invention for coordinated powertrain control,

FIG. 15 a software system according to FIG. 13 in the selection of the optimization criterion,

FIG. 16 an exemplary prioritization sequence corresponding to FIG. 15, for the selection of the optimization criterion by the vehicle coordinator,

FIG. 17 a schematic structuring according to FIG. 13 in the driving command interpretation,

FIG. 18 an exemplary prioritization sequence analogous to FIG. 16 in the driving command interpretation,

FIG. 19 an exemplary request of a plug-in,

FIG. 20 a schematic structuring according to FIG. 13 for the determination of the optimal operating point,

FIG. 21 an exemplary prioritization sequence corresponding to FIG. 20, for the determination of the optimal operating point,

FIG. 22 a schematic structuring according to FIG. 13 for the approach to the optimal operating point,

FIG. 23 an exemplary prioritization sequence corresponding to FIG. 22, for the approach to the optimal operating point, and

FIG. 24 a schematicized structuring according to FIG. 13 in the use of individual plug-ins by various interfaces.

### PREFERRED SPECIFIC EMBODIMENT A MODULE TYPE OF SYSTEM CONSTRUCTION (ALSO KNOWN BY THE NAME CARTRONIC, OF THE FIRM OF BOSCH) FOR ALL CONTROL TASKS AND REGULATING TASKS IN THE VEHICLE IS AN OPEN SYSTEM ARCHITECTURE

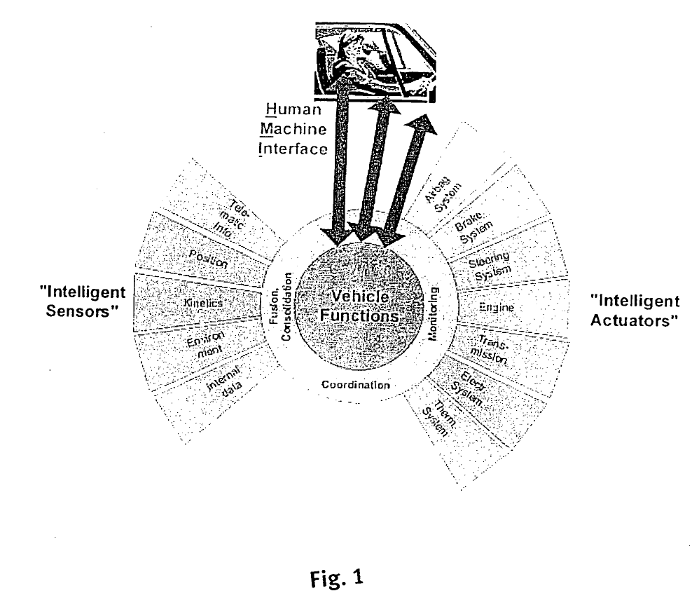

The vision, on which the modular system construction is based, organizes the intelligent vehicle of the future into three essential elements, as in FIG. 1:
intelligent sensors record all the data important to vehicle operation. To this belong, for example, sensors for recording motion data such as speed, acceleration and rate of rotation, sensors for vehicle-internal variables such as temperatures and pressures, and in future also increasingly sensors for recording the vehicle environment (such as ultrasound, radar, video).
intelligent actuators safely and reliably carry out the required control commands. Intelligent, electronically controlled actuators are, for example, the powertrain, made up of an internal combustion engine and a transmission for generating the propulsion torque, electronically regulated braking systems for specified deceleration and stabilization of the vehicle and electronically regulated steering systems for a safe and sensitive tracking. These interventions will in the future increasingly be made electronically controlled and monitored “by wire”.
a human-machine interface (HMI) gives the driver the data relevant for him in the respective driving situation, and permits the safe and comfortable operation of the vehicle via the operating elements of the cockpit.

Today's vehicles, as a rule, are characterized by grown electronic structures, having a multiplicity of isolated and autarchic individual functions and control units. Therefore, the development is mostly limited to optimization of the isolated individual functions and subsystems, but optimization of the overall system is taking shape with difficulty.

Therefore, to implement the vision of networkable systems in a vehicle, a coninual, consistent, modular and open system architecture becomes necessary. The aim of the system architecture is the seamless integration of all subsystems for the efficient representation of superordinated vehicle functions, which make it required to have several subsystems interact. Further aims are flexibility with respect to different vehicle configurations and control unit configurations, a simpler implementation of customer-specific functions, as well as great functional safety and reusability of developed software components.

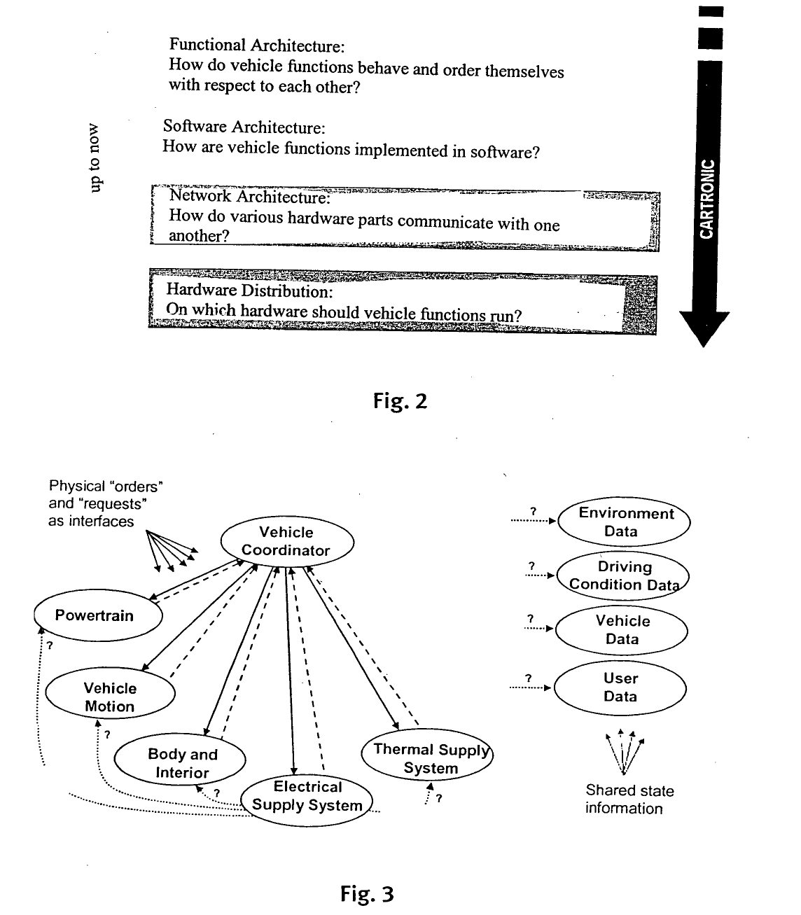

By the abstract concept of “architecture”, both the systematology of the structuring of a complex system composite and its practical putting into use are understood. To describe the architecture, different views may be distinguished which are each shown by their own deascription (in the sense of differently abstract to concrete models), that are generated and made real in the individual stages of a development process, see FIG. 2.

The basis of the system architecture of the module type of system construction is a hierarchically clearly structured functional architecture that is oriented to the vehicle topology, see FIG. 3. The functional architecture describes the order and connection of logically modular functional components: their tasks, their interfaces as well as their interactions among one another. Essential elements of the functional architecture are domains, (sub)systems, functional components and communications relationships. The resulting abstract model is still independent of implementation using a special hardware topology.

The functional architecture subdivides the vehicle into different “domains”: vehicle motion (powertrain), drive (vehicle motion), body and interior, electrical supply system, thermal supply system, etc. Inside each domain different subsystems are identified, which are made up of “functional components” that interact with one another via communications relationships. The concept component does not necessarily mean, in this context, the physical unit in the sense of a component part, but rather a functional unit which, as a subsystem, may be split up into further functional subcomponents.

Each of the subsystems itself coordinates its subcomponents, but the coordination of the subsystems is taken over by special functional components that are designated as coordinators. In the case of the communications relationships, the four basic types instruction, requests, feedbacks and polling are distinguished. A request is the wish to have a task executed, while an instruction is connected with the duty to execute it. While possibly several different functional components are able to place similar or even conflicting requests (for instance, different users a drive torque of an engine), placing the instruction takes place by exactly one instruction giver (e.g. a powertrain coordinator) to exactly one instruction taker (e.g. the internal combustion engine). If necessary, the instruction taker gives the instruction giver a feedback regarding the execution.

The functional architecture may be depicted graphically or even by UML models. Independently of the selected forms of description, the structuring rules on which this is based yield a consistent method, especially in the phase of systems analysis, for mastering the complexity, and permit the systematic definition of functional interfaces.

The next step in the development process is converting the functional architecture into a suitable software architecture. The software architecture describes the structures of the software of the system, and it is made up of software components which, within themselves, may be subdivided into additional software subcomponents. In general, the functional scope of a software component does not necessarily have to be equated to a functional component of the modular type of system construction. The functional structuring of components of the module type of system construction does, however, support and object-based software design.

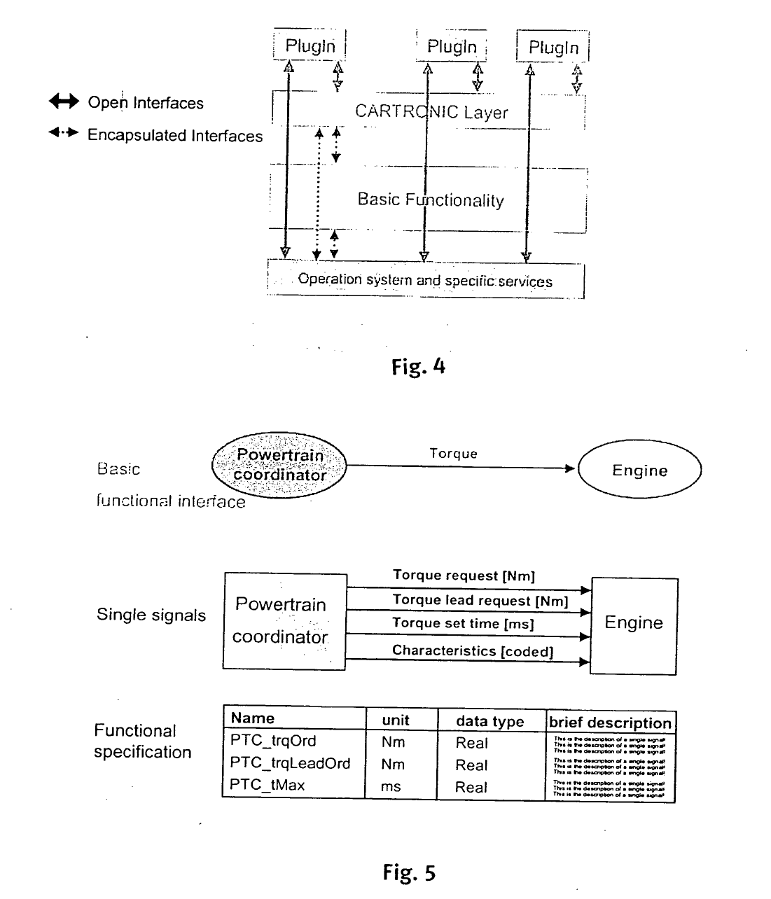

FIG. 4 shows a product-oriented, schematicized view onto a software architecture, according to the present invention, that is based on the module type of system construction. The following elements may be distinguished in a simplified manner:
“operation system and specific services” having an operating system and specific services as a basis for application, which are supposed to run on the control unit;
“basic functionality” designates basic functions of the control unit for carrying out universal requests (e.g. activating the actuators of an internal combustion engine). The base functionalities are ascertained and structured from the functional architecture;
“layer”: this software component carries out the coordination tasks for several base functionalities and links in plug-ins;
“plug-in”: these software components carry out concrete, separable tasks that go beyond the base functionality and are coordinated by the component layer.

In this partitioning, open and encapsulated interfaces may be distinguished. Encapsulated interfaces are not accessible from the outside, whereas open interfaces may be freely accessed. The modularity of this software architecture supports the exchangeability of subfunctionalities and thus makes possible software sharing.

For the implementation of the system composite, the partitioning of functions to concrete control units and the mapping of communications relationships on the network topology play a decisive role. Whereas in the traditional attempt at a grown system, in the first step, the partitioning of the control units and their networking were specified, and functional architecture and software architecture had to orient themselves to these actualities, the module type of system construction, in the present case, supports a systematic, simultaneous development process.

Because of the coordination of distributed systems on which it is based, the module type of system construction permits a flexible system implementation, both in decentralized distributed and in centrally concentrated control unit partitionings. Also, with respect to the use of specific bus systems and communications standards, the module type of system construction permits a great flexibility by encapsulation of the interfaces connected therewith. The specifically different topologies, depending on market segment and manufacturer, are therefore supported by the module type of system construction with a high degree of reusability of functional components and software components.

As the preceding comments have shown, clearly defined, standardized interfaces form a core element for managing the challenges of a composite system.

The system architecture supports the development of universal interfaces. Depending on the view, in this context, different implementation forms may be distinguished, see FIG. 5:
basic functional interfaces, which, starting from a simplified form (example: the torque request to the internal combustion engine) are detailed into abstract signal interfaces (example: the detailing of the torque request in the form of an instantaneous setpoint torque (torque request), a longer-period torque lead request, and, for instance, additional dynamic data and status data (torque set time, characteristics),
specific software interfaces within a control unit, the functional interfaces being supplemented by software-technology requests (example: the coding of the torque request in the form of variable names, data types, scalings, amplitude quantification and time quantification for an instantaneous setpoint torque, reference variable, dynamic data and status data),
as well as specific signal interfaces on a bus between control units (example: the coding of the torque request in the form of signal names, data types, scalings, amplitude quantification and time quantification, as well as bus addresses for an instantaneous setpoint torque, lead torque, dynamic data and status data).

An essential advantage is that the different interface forms may be transparently assigned and mutually converted. Thereby, at the time of developing a software function, considerable independence may be ensured of the software interfaces from the actual transport mechanism of the information (within a control unit or via a bus). By the encapsulation of specific subsystem properties, it may additionally be ensured that the interfaces are independent of the technical embodiment of the connected subsystems. An example is given by the torque interface to the internal combustion engine, which is universally suitable both for gasoline engines and Diesel engines.

This architecture supports the seamlessly functional integration of different electronic vehicle systems. In addition, the plug-in concept permits implementing software modules for the characteristic layout of the vehicle performance.

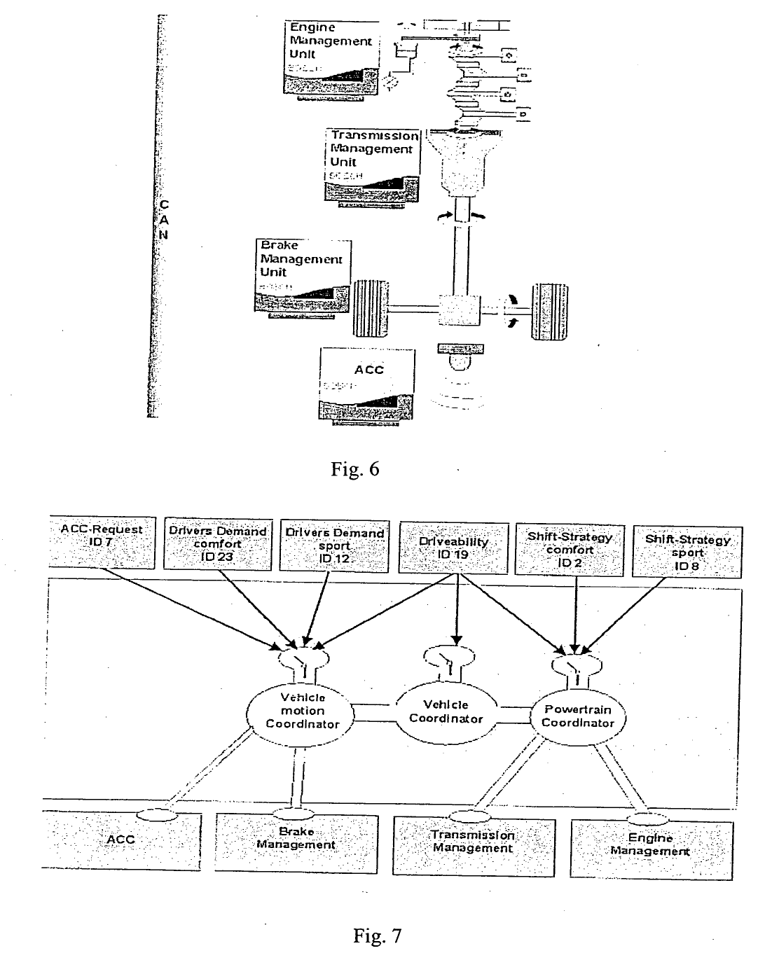

FIG. 6 shows symbolically the layout of a vehicle. The engine control EMU (engine management unit) is connected to the sensors and actuators of the engine, as well as to the sensor of the accelerator module. Furthermore, the vehicle has available to it a brake control unit BMU (brake management unit), an electronic transmission control TMU (transmission management unit), as well as an ACC control unit, which processes the signals of the radar sensor. A CAN (controller area network) bus connects the control units to one another.

The layout permits the flexible configuration for different vehicle characters, designated below in exemplary fashion in two forms as “sporty” and “comfortable”. A switch in the passenger compartment enables the driver to switch over between these two vehicle characters. By contrast to the usual implementations of such vehicle characteristics, the difference is based not only on different parameter applications within the individual systems, but rather, on a superordinated plane, one draws upon software-“plug-in” functionalities to adapt the overall system behavior, which address via interfaces the individual systems that are unchanged in each case with respect to software and setting.

In order to represent the comfort character of a limousine of premium class, for example, the following requests were made as an example:

The vehicle should get an adaptive cruise control (ACC) system. This system makes possible an adaptation of the speed to a driving specification, as well as the distance from preceding vehicles, in that drive and brakes are activated electronically. ACC is an innovative equipment feature that emphasizes the premium character and increases travel comfort.

Electronic braking interventions for ACC and other longitudinal regulating systems (as, for instance, a driving speed regulator having brake intervention) should be possible via the brake control unit (BMU, brake management unit).

During throttle response, the vehicle should convey a soft feel, that is, jerky starting is to be avoided. Likewise, load reversals should be gentle, that is, the characteristic dynamics of the drive train should under no circumstances be perceptible to the driver. Gear shifting should be oriented rather to economical operation, i.e. the engine should primarily be operated at low rotary speeds.

In the sporty vehicle character, travel pleasure was optimized as the highest aim. In correspondence to the specified vehicle character, drive control and engine control should be designed as follows:

The engine should spontaneously respond to throttle, i.e. the accelerator interpretation should be “sharply” applied. Load changes should be able to take place rapidly, that is, the damping for the suppression of the drive train dynamics is secondary with respect to spontaneity. The engine operating point should be designed in favor of high rotary speed, so that the driver has as big as possible a power reserve available to him at all times.

For the demonstration of great flexibility, in this layout, one may do without incorporating the comfort feature “ACC”.

FIG. 7 shows the software architecture according to the present invention that is used for implementation using plug-in design in the layer view:

The uppermost layer is formed by six plug-ins, which contain the characteristic functions for implementing the requests to the two vehicle characters:
ACC request:
   a control loop takes care of the adjustment of the speed or the clearance. The controller is typically a component of the ACC control, and has an acceleration as control variable. ACC request takes this over and feeds it as a request to the vehicle motion coordinator.
drivers demand comfort or sport (shown separately in FIG. 7):
   an electronic accelerator is evaluated in this component, and interpreted as propulsion torque at the drive output. This function has a strong influence on the vehicle performance, and thus, on the brand character. The comfort plug-in contains a soft accelerator interpretation, whereas the sporty variant is designed sharp, that is, a high rotary torque at comparatively little accelerator travel. The calculated propulsion torque at the transmission output is set as a request to the vehicle motion coordinator via the interface.
driveability:
   is used among other things to determine a global optimization criterion, that is, in one case “travel comfort” and in the other case “sport”. Additional component parts of this component are the comfort functions for load reversal filtering, i.e. changes in the setpoint torque are damped in such a way that no disturbing jerking or vibrations appear in the drive train. This rate-of-change limitation prevents the excitement of drive train vibrations in the range of natural frequencies. A minimum and maximum gradient of the drive setpoint torque may be specified to the vehicle motion coordinator via an interface. In addition, driveability evaluates the switch by which a switchover may be made between the sporty and the comfortable vehicle character. As an alternative to a switch, a driver type recognition could also be implemented for this purpose. The mode that is selected is subsequently routed to the vehicle coordinator. An additional feature makes it possible to avoid the jerk during gear changes, by purposeful control of the engine torque, in that a minimum and a maximum engine torque, that is to be maintained, is transferred to the powertrain coordinator.
shift strategy comfort or sport (shown separately in FIG. 7):
   includes a calculating rule that, from the setpoint value for the torque at the transmission output and the vehicle speed, determines the setpoint value for the transmission ratio and the engine torque. In order to satisfy the specification of the setpoint torque, with respect to the current speed, there comes about one degree of freedom in the selection of the transmission ratio. The transmission ratio is selected either in favor of an economical engine operating point (shift strategy comfort) or in favor of a high performance reserve (shift strategy sport). Both the setpoint value for the transmission ratio and for the engine torque are sent to the coordinator powertrain. In addition, there is also included a function for the suppression of superregenerative circuits. A minimum or maximum admissible gear, that is to be maintained during shifting, is specified to the powertrain via the common interface.

In FIG. 7, below the plug-ins, there is located the layer that includes the coordinators vehicle coordinator, vehicle motion coordinator and powertrain coordinator. Each coordinator has available to it any number of versions of a clearly defined, fixed interface for communication with the plug-ins. For each plug-in that wishes to communicate with a coordinator, the latter makes available an additional version of its interface. In this case, vehicle motion coordinator, for example, is connected to altogether three plug-ins: ACC request, driver's demand and driveability. The uniform interfaces make possible the representation of a broad spectrum of functionality in the plug-ins. While the coordinators supply the plug-ins with all global vehicle data, by contrast, the interfaces in the opposite direction, that is, from the plug-ins to the coordinators, are comparatively narrow-banded. There are frequently conflicts, within a coordinator, between competing requests (e.g. simultaneous propulsion command by the ACC and via the accelerator). These may be decided in favor of a specifiable strategy, with the aid of a flexible prioritization method. In an applicable prioritization table it is determined which plug-ins are to be called up. The principle of this prioritization method is made clearer below, using the example of the vehicle motion coordinator.

The layer is connected to the lower-lying software layer of the basic functionality via standard interfaces. From the point of view of the layer, these base functions behave like intelligent sensors or actuators. For example, component engine management functions as a torque setter, transmission management carries out the commanded transmission ratio, brake management sets the requested setpoint acceleration and ACC supplies the data from object recognition and ACC operating part.

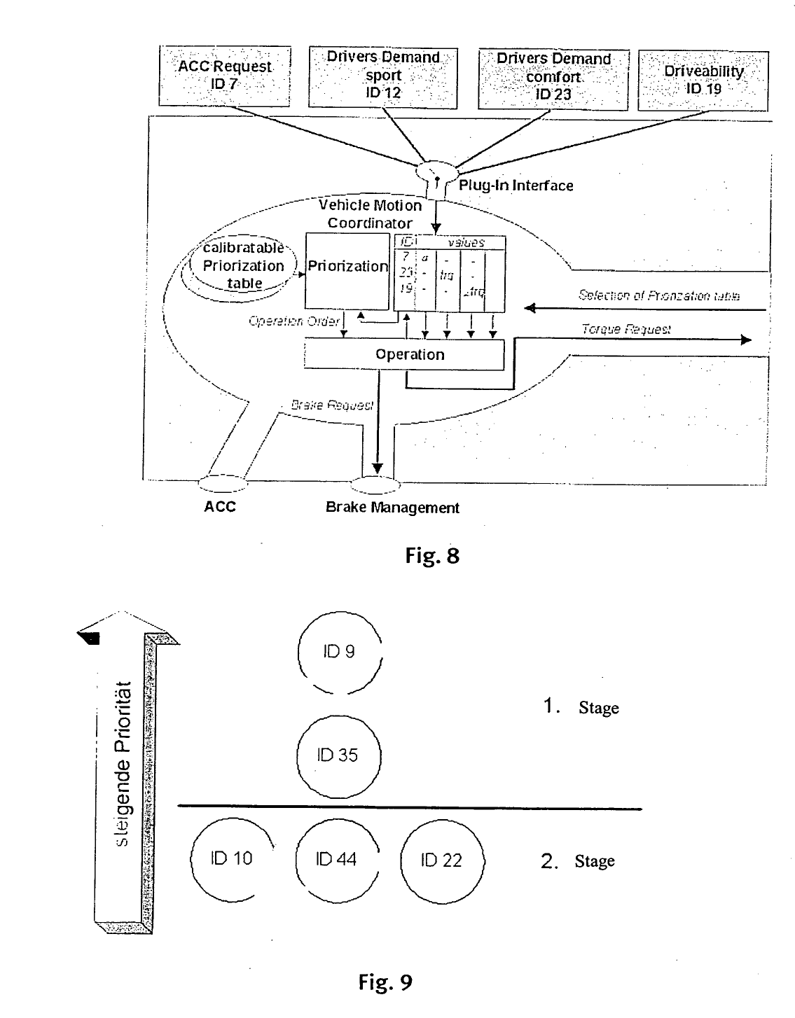

FIG. 8 shows the inner construction of the vehicle motion coordinator from FIG. 7. The data of the plug-ins are read into a buffer via uniform interfaces. In each case, the interface data are made up of the identity (ID), which uniquely characterizes each plug-in, as well as a use proportion (values), which determines the functionality. For example, if ACC request has ID 7, and sends an acceleration request (a), drivers demand sport (ID 12) sends a propulsion torque at the transmission output (trq) and driveability (ID 19) an upper and lower limit for the gradient of the propulsion torque at the transmission output (trq). A suitable prioritization method (priorization), in this case a linear prioritization, establishes the operation order of the requests from the plug-ins and communicates the result to the system carrying it out (operation). The priorities may be applied for each ID in a prioritization table or prioritization list (calibrate prioritization table). To represent different vehicle characters, several prioritization tables may be stored simultaneously, e.g. for “sport” and for “comfort”. In this case, for example, the prioritization table for “comfort” includes only the call-up of the plug-in drivers demand comfort (ID 23), whereas, for example, the plug-in dirvers demand sport (ID 12) is not called up. In reverse, the prioritization table for a sporty driving operation includes only one entry of plug-ins dirvers demand sport (ID 12) and driveability (ID 19), ACC request (ID 7) being purposefully not taken into consideration. The selection of the prioritization table is made by the vehicle coordinator. The executing unit (operation) calls up the requests of the plug-ins according to the specification of the operation, and processes it.

As a result, a setpoint acceleration is ascertained which is distributed to the actuators drive (engine and transmission) or brake. In the case of braking, it is passed on to brake management via the interface. In the drive case, the acceleration is recalculated, with the aid of the traction force equation, to a setpoint torque at the transmission output, and then there follows the coordination with the request from driver's demand. As a rule, the request having the greater torque request prevails. In exceptional cases (depending on the) prioritization table) it may, however, also be meaningful that the decision is made in favor of the acceleration request of the ACC. For example, it proves to be comfortable when the brake deceleration is not ended abruptly if there is active braking of the ACC, and the driver is accelerating at the same time, i.e. when the driver is overriding. The resulting setpoint torque at the transmission output is subsequently passed on to the vehicle coordinator (see also FIG. 7).

The vehicle coordinator passes the setpoint torque on to the powertrain coordinator (see also FIG. 7), and establishes the calculating sequence of all coordinators. In addition, it ensures the carrying out of the global driving strategy. This is determined by driveability in the form of a global optimization criterion (comfort or sport) appropriately to the switch setting, and is sent via the common interface. Based on the optimization criterion, the vehicle coordinator establishes the prioritization tables in the coordinators that are to be used.

The powertrain coordinator carries out the request for implementing a transmission output torque by the vehicle coordinator. Simmilarly as in coordinator vehicle motion, in the light of a prioritization method according to the present invention, the processing order of requests from the plug-ins, shift strategy comfort or sport, as well as driveability are determined. Depending on the prioritization table selected, only one of the two switching strategies is called up via the ID. Transmission management is instructed to carry out the setpoint value, while taking into consideration the minimum or maximum admissible gear from shift strategy. When there is a gear change, engine torque is transferred to base function engine, according to the specified lower and upper limit from dirveability.

All requests for the characters sport and comfort were able to be successfully carried out using altogether six plug-ins. Using the switch in the passenger compartment, one may switch over between the two modes during travel. The integration of the ACC system in the comfort version took place without change in the layer. This substantiates the power of the interfaces to the plug-ins, and permits the future integration of other applications, such as a situation-dependent speed limitation or cruise control having brake intervention as an alternative to ACC. The standardized interfaces of the layer to the base functions, such as engine and transmission, also makes possible decoupling the driving functions from the assemblies: they make possible the use of the same driving functions for different engine types (for Otto engines and Diesel engines) and different transmission types (e.g. for stage automatic transmissions and CVT.

Using the applicable prioritization method, dynamic changes between different driving behavior modes also become possible if this is requested, for instance, using a driver type recognition. In the present example, the change between the types sport and comfort of the plug-ins drivers demand and shift strategy demonstrates the flexibility of the prioritization method for the exchangeability of whole algorithms.

In contrast to the usual systems, which only permit a different characterization of the vehicle behavior by parameter change in isolated subsystems, the system architecture according to the present invention permits a far-reaching, flexible brand characterization of the overall vehicle by plug-ins along with simultaneous reuse of the software it is based on.

We are dealing with an overlapping, open system architecture for all control tasks and regulating tasks in the motor vehicle. It is independent of the vehicle type and of the control unit configuration. It is based on a clearly structured, hierarchical functional architecture and modular software having open, uniform interfaces in the participating control units. With that, the tasks may be distributed flexibly to individual hardware components of the electronic system. The ever more complex vehicle systems may be mastered more easily.

It was shown in an example that a flexible brand characterization is supported according to a top-down formulation. The characteristic functions for driveability are respectively concentrated in a plug-in. An applicable prioritization method makes possible the flexible coordination of the plug-ins. Thereby one succeeds in representing entirely different vehicle characters using a low software expenditure. Specified interfaces permit the modular integration of additional system elements. The plug-in concept makes it easy to share software, which gives the OEM (original equipment manufacturer, i.e. the automobile manufacturer) the possibility of characterizing his brand by independently developed software modules. A large measure of reusability of the software components, on which it is based, supports the requests according to cost effectiveness and software quality.

In motor vehicles, one normally has to choose between different propulsion requests, which come from either the driver or from auxiliary systems, such as FGR, ACC and ANB. The control unit software includes a program part that selects the most important requester.

During the implementation of the selecting method it is known which systems are able to make requests and how they are weighted with respect to one another. These requests are linked with one another in a fixed logic.

The methods used up to now have the disadvantage that it has to be known right from the beginning which system is able to make propulsion requests and what request combinations are able to exist. Because of that, the method has to be adjusted for each combination of systems.

The aim of the present invention is a method by the use of which one may meet the selection of the passed-on request or desire, especially for propulsion, independently of the number and the functioning manner of the requesting systems.

With the aid of a prioritization method according to the present invention, especially as a linear prioritization or as a maximum (minimum) selection, the selection of a passed-on requester or plug-in may be met independently of the number and the functional manner of the requesting systems. In the linear prioritization, a list or table of requests is processed sequentially, beginning with the requester having the highest priority, this list being sorted for linear prioritization, according to the degree of the priority of the requesters. Ending the polling of the list takes place as soon as a requester includes a request command. The requester is thereby selected. The remaining requesters that have not yet been polled are consequently not considered.

In the max (min) selection, all requesters are polled that are on the list for the max (min) selection. The requester having the maximum (minimum) request command is selected.

One may also combine the two methods with each other at will, for instance, by first carrying out a linear prioritization, and thereafter a min selection, in case the linear prioritization gives no result.

In the following, we describe, for example, the sequence of the selection of a propulsion command. The system includes, for instance, the following requesters:
accelerator (ID 10)
automatic emergency brake (ID 9)
brake pedal (ID 35)
FGR (ID 44)
idle controller (ID 22)

The method used in the example, for ascertaining the most important propulsion command, is made up of 2 steps:
linear prioritization (e.g. as first step)
   Here a list is sequentially worked through, and as soon as a requester has a request command, the procedure is stopped. The higher the position of the requester on the list, the higher is its priority,
max selection (e.g. as 2nd step)
   All requesters are polled. The command having, for instance, the highest propulsion torque is selected.

FIG. 9 shows a graphic representation of a linear prioritization according to the present invention (1st step) and a max selection (2nd step). In the linear prioritization, requester ID 9 (automatic emergency brake) has the highest priority and is polled first. Requester ID 35 (accelerator) has a subordinate priority, i.e. it is polled subsequently. In the max selection (2nd step), requesters ID 10 (accelerator), ID 44 (FGR) and ID 22 (idle controller) are of equal value in the same prioritization step, and they are all polled. The command having, for instance, the highest propulsion torque is selected. The two methods may be used both separately and in combination.

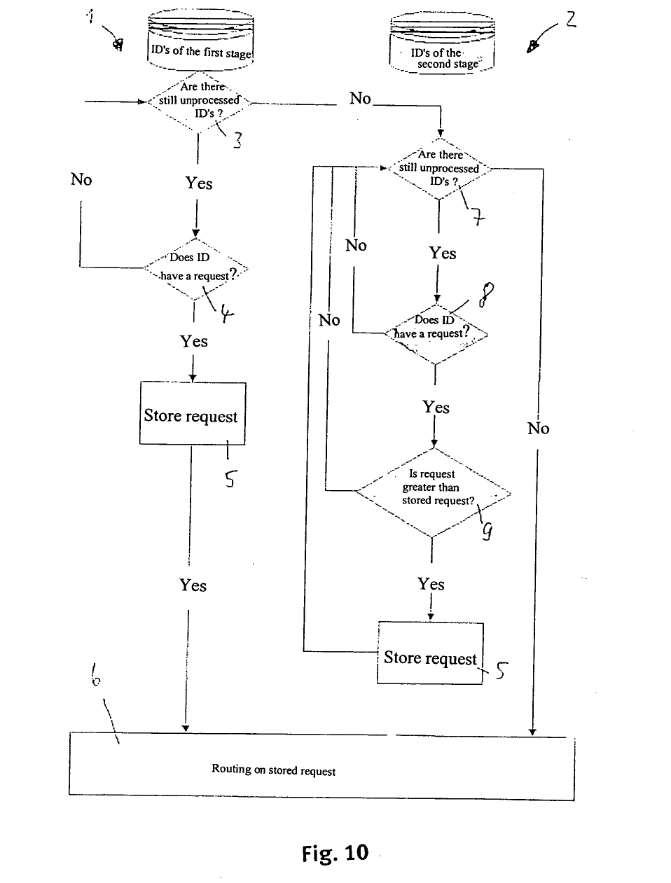

FIG. 10 shows a flow chart of a prioritization method, the linear prioritization (1st step) being combined with the max selection (2nd step). The left half shows linear prioritization method 1, and the right half shows max selection 2. In linear prioritization method 1, in first operational step 3, it is first polled whether there are still unprocessed IDs present, e.g., corresponding to FIG. 9, ID 9 and ID 35. In operational step 4, in response to the polling as to whether an ID has a request, if yes, the request is stored 5 and passed on 6, and therewith the method or flow chart is ended, and if no, going back to previous operational step 3, it is polled anew whether there are still unprocessed IDs present, and the method is continued until one ID having a request is present. The processing of the IDs takes place in the sequence of their prioritization, e.g., in FIG. 9, ID 9 and, after that, ID 35. If none of the IDs in the 1^{st} step has available to it a request, the procedure goes over to the IDs of the 2nd step, e.g., in FIG. 9, to ID 10, ID 44 and ID 22.

In the second step having max selection 2, it is polled in first operational step 7 whether there are still unprocessed IDs present. If yes, it is polled in next operational step 8 whether an ID has a request. If there is no request present, the procedure goes back the preceding operational step 7, and if yes, it is compared in next operational step 9 whether the just-polled requester is greater than an already stored requester. If no, the procedure jumps back to operational step 7, and if yes, the request is stored 5. If all IDs of the 2^{nd} step have been polled, i.e. in operational step 7 there are no more unprocessed IDs present, the procedure jumps to operational step 6 for passing on the stored request. Thereby, for the IDs of the second step, the greatest request may be ascertained and passed on, in case the IDs of the first step include no request, since it was used in combination with the linear prioritization. As a further method, for example, an average value formation or a combination of these methods should be considered. For many real application cases this method will not be sufficient. In the following, two additional construction stages of the system are described:
Broadening by min/max Selection
   As soon as the requesters are able to control not only the engine, but also the brakes, the method described in the example is not sufficient, since a braking intervention should possibly have a higher priority than an acceleration intervention. To take this circumstance into account, the 2nd stage has to be changed from a max selection to a min/max selection. The min/max selection works as follows:
   As soon as a requester requests a brake intervention, the lowest propulsion command (maximum deceleration) wins. If there is no braking intervention, the maximum acceleration is selected.
Broadening by Authorities
   The method described above does not correspond to the currently usual methods, since the accelerator is able to override a braking intervention of the FGR or the ACC. For this reason, the method described may be broadened by one more stage which is called authorities.
   In this method, each requester is able to screen out certain request ranges during the min/max selection. This means, that, for instance, the accelerator is able to screen out all braking interventions. Thereby all braking interventions are ignored during the min/max selection, but not, for example, the brake that would be settled in the linear prioritization.

In order to handle the IDs efficiently, they are managed in lists that are processed sequentially. Adaptation of the priorities to global optimization criteria (such as economical setup, sports setup or winter detection) can take place if the IDs are managed in 2-dimensional lists and, depending on the global optimization criterion, another row is used.

Now, if a requester is to be added, it should be entered into the right tables and it will thereby be automatically considered at the next selection.

It has to be excluded that an invalid request is routed to the engine or the brake. For this reason, it has to be ensured that the system is either preinitialized by having a valid value or it has to be guaranteed that, upon each selection, always at least one requester requests a value.

In the anonymous prioritization methods of information providers according to the present invention, the selection method does not know which quality the requester has. The only data it has are the ID and the position in the respective tables of the selection method. This leads to the fact that there are no inner dependencies of the requester and the selection system. Such a selection system is always required if one is to change the number of requesters without changing the code of the selection method. This method may be used, for instance, in an engine control, as shown by the above example. But there are still many additional products with regard to which this method has advantages.

The advantages of the prioritization method are, for example:
no dependencies among selection method and requester, and therewith increased software reuse of the selection method and the requester (FGR, accelerator, . . . ),
reduced code use and calculating time use in the case of complex systems (many requesters), since the selection method is independent of cross-relationships of the requesters,
easier ability to broaden the system (addition of further requesters). As long as the requesters are able to use the offered, abstract interfaces and sufficient memory for the ID tables has been reserved, the system may be extended by any number of requesters without having to change program codes.
changes among sets of priorities possible during running time and
the system may be extended in the future by a dynamic log-on request by requesters.

Below we shall describe an additional, concrete, procedure as regards contents for a modular system construction.

According to the present invention, a method for controlling, especially a method for coordinating powertrain control of motor vehicles is divided into 5 phases or steps:
1. characterizing the environmental influences
2. establishing a global optimization criterion
3. interpreting driver command
4. determining optimum operating point
5. approaching optimum operating point

In the 1st step of the coordinated powertrain control, current environmental data are prepared, if necessary typified, and made available. The following data groups are of interest, for example:
vehicle variables:
   general current vehicle data such as speed and transverse acceleration
drive train condition:
   current drive train data such as frictional connection and trailing throttle/drawing operation
driver type recognition:
   observes the driving behavior and the activities of the driver, and derives from this an abstract type (e.g. sporty or economical)
driving situation recognition:
   based on derived signals, draws conclusions on the current environmental or driving situation, such as hill, curve, winter, city, expressway.

The 2nd step establishes what it is, based on which the entire following method is to be optimized. Criteria are conceivable, for instance, such as sporty driving manner, economical driving method or especially wear-preventive driving manner. The advantage of the global establishment lies in the subsequent uniform use in all decisive functions, from the acceleratot interpretation to engine torque selection and transmission ratio selection.

The subsequent driver command interpretation in the 3rd step has the task of interpreting the specifications of the driver and to derive therefrom a specification for the longitudinal motion of the vehicle. Besides the pure accelerator interpretation according to acceleration and deceleration, this includes also the specifications of a speed regulator or an ACC, which carry out the command of the driver for automatic travel at constant speed. A system reference variable transmission output torque, which includes acceleration and deceleration, is divided into a variable transmission output torque for the powertrain and a variable vehicle deceleration for the brake.

The driver command interpretation supplies as result a transmission output torque that is to be made available by the powertrain (the required auxiliary component power would still be added to this). For this, there now has to be determined an optimum operating point in the 4th step, to which an optimum of the selected optimizing criterion (see 2^{nd} step) should be oriented. An operating point comes about in a conventional powertrain from the engine torque and the transmission ratio of the transmission, because the rotary engine speed, at a given vehicle speed, may be directly calculated from it. For future concepts, by installing further assemblies, there may perhaps come about additional degrees of freedom (e.g. an e-machine in 4-quadrant operation).

The last task of the coordinated powertrain control is the approach to optimum operating point in the 5th step. The current and the new optimum operating point may, under certain circumstances, lie relatively far “apart” (e.g. when the driver suddenly steps on the accelerator). In order to assure driveability, comfort, safety and assembly protection it is therefore frequently sensible not to permit any abrupt transition (as quickly as possible), but to approach the new operating point in damped fashion.

After the 5th step, the new operating point is established, and the appropriate specifications may be given to the components in the powertrain.

In phases 2 to 5, the actual design as to content of the task of the phase is assumed by plug-ins. For this, from each phase an appropriate interface is offered, via which (at least) one or more plug-ins are able to introduce suggestions of requests. These suggestions are first compared to one another by a phase-specific prioritization method according to the present invention, and the selected request command is routed subsequently by the phase, actually as specification to the next phase. Various methods are used for prioritization (simple rank sequence, maximal selection, average value formation and combinations of these methods).

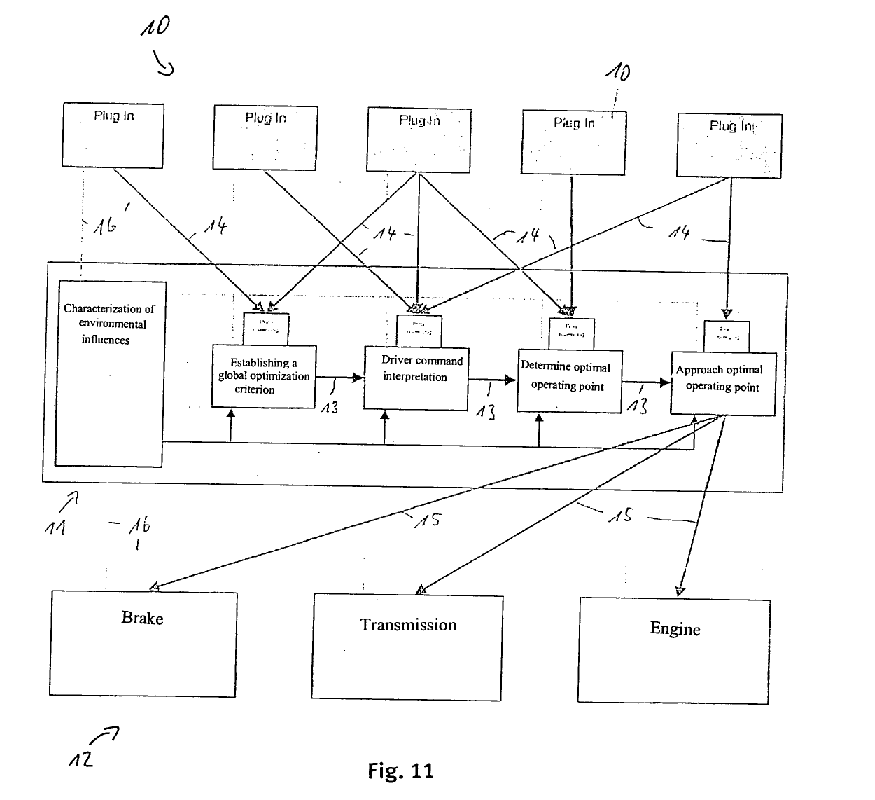

FIG. 11 the sequence according to the present invention is shown once more. The sequence of the 5 phases is shown in the sense of an intermediate layer 11 (layer, see next paragraph) between plug-ins 10 and drive train components 12. The data which are routed from one phase to the next phase are marked by 13. Requests and specifications that are made by the plug-ins to the individual phases are marked by 14. The specification of the new operating point, finally established in the last phase, to drive train components 12, is marked by 15. Arrows 16 characterize the information flow of general state variables and vehicle variables that are able to be used within the phases or plug-ins for processing their functions.

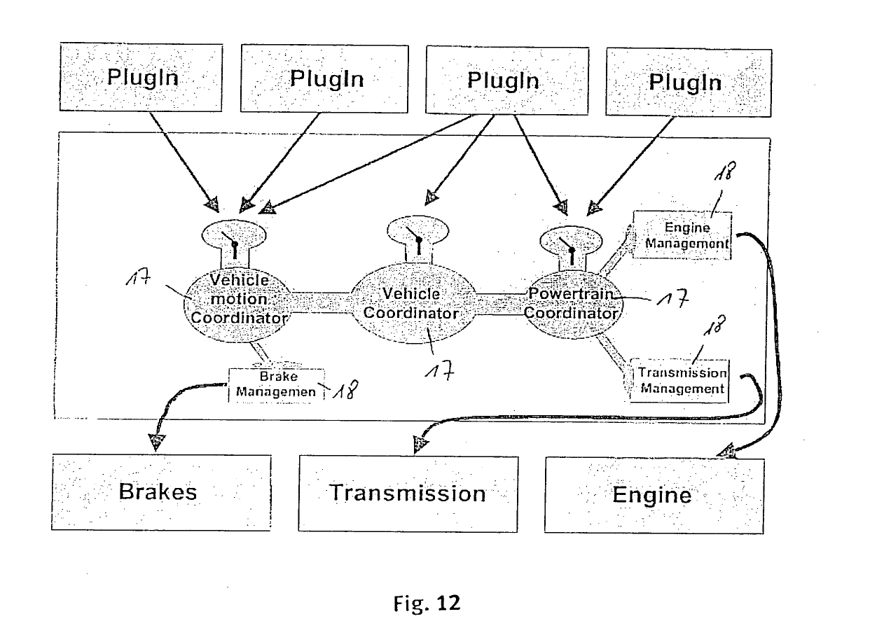

For the development of the phases it is favorable to use a structure that is hierarchically oriented corresponding to the components and functions in the vehicle. For this, the modular system construction was used (see FIG. 12). The latter illustrates the drive train topology in the software, and makes possible, by mechanisms for exchangeability, the simple adaptation to changes of the vehicle configuration. The tasks of the 5 phases were distributed to coordinators 17, which are provided as to content for this task. In addition, so-called interfaces 18 have been introduced, which take care of the communication with the physical components engine, transmission and brakes.

In the following, the subdivision of the individual phases within the structure according to the present invention is shown, and the sequence of the entire powertrain control according to the present invention is explained once more in detail, especially with the aid of examples:

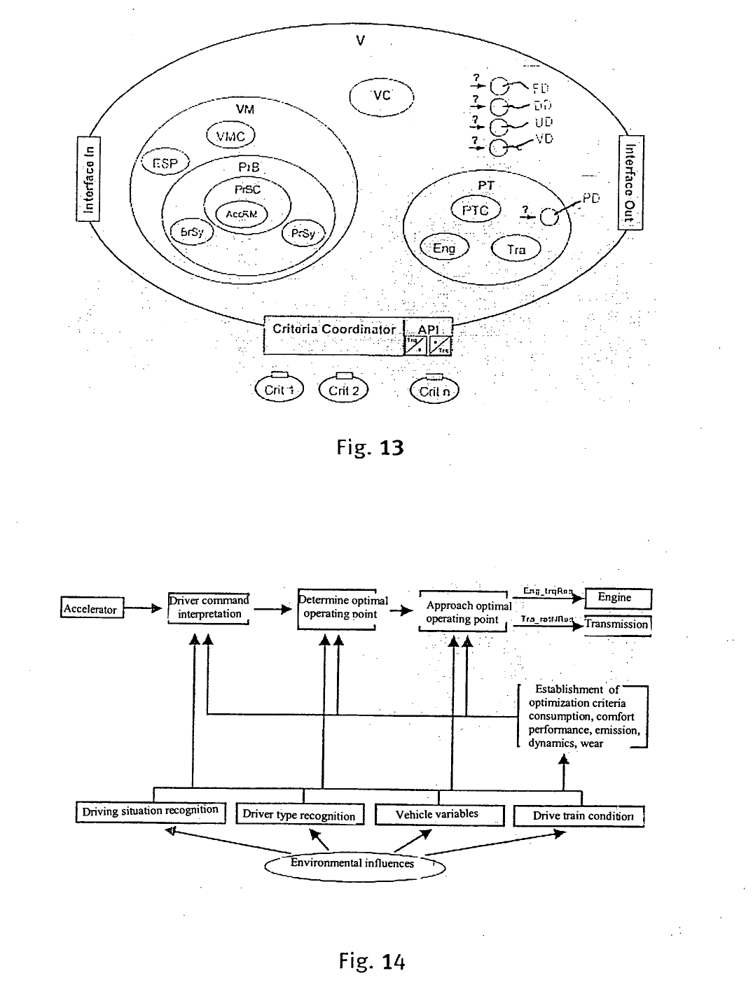

FIG. 13 shows the hierarchical structuring or architecture as an object-oriented software system according to the present invention for the coordinated powertrain control. It is constructed in the form of ellipses nested within one another or drops for software components, a software component situated in another, larger ellipse being a partial component of the larger software component. The object-oriented overall software (vehicle, V) is made up essentially of vehicle motion VM, which is responsible for ascertaining and coordinating all longitudinally dynamic requests to the vehicle, and the powertrain, PT, which has the task of implementing these requests. Also shown are vehicle coordinator, VC, criteria coordinator, CC, interface in and out, the (special) application programming interface, API, and the components characterized here by question marks, for environment data, ED, such as winter, driving condition data, DD, such as speed, user data, UD, such as driver type and vehicle data, VD. The reference variable, to which the entire system refers, is the transmission output torque.

The system is thereby broadened by interface in and out, which is supposed to indicate that the individual software components for a functionable software also have to be connected to the real components and linked with additional control systems, and that for this, a special mechanism of software technology is utilized.

The interface criteria coordinator takes on a special status with regard to an undetermined number of plug-in components, Crit x In order to be able to simply broaden the system by any functions for coordinated powertrain control, these are transferred to plug-ins, and communicate with the system via a specific interface. In the light of the following figures, it is described how the functional subdivision between the system and the plug-ins and the appertaining communications proceeds.

FIG. 14 shows the 5 steps of the method according to the present invention for the control, especially for the coordinated powertrain control, of motor vehicles. The characterization of the environmental influences in the information group driving situation recognition, driver type recognition, vehicle variables and drive train condition takes place in step 1. In the 2nd step the optimization criteria are established, for instance, consumption, comfort, performance, dynamics and wear. In the light of the accelerator setting, the driver command interpretation is carried out in the 3^{rd} step. in the 4th step, the optimal operating point is determined, and in the 5^{th} step it is approached in that appropriate specifications are made to the engine and the transmission.

In FIG. 14, in the 1st step of the coordinated powertrain control, current environmental data or environmental influences are prepared, if necessary typified, and made available:
vehicle variables:
   general current vehicle data such as speed and transverse acceleration
drive train condition:
   current drive train data such as frictional connection and trailing throttle/drawing operation
driver type recognition:
   observes the driving behavior and the activities of the driver, and derives from this an abstract type (e.g. sporty or economical),
driving situation recognition:
   based on derived signals, draws conclusions on the current environmental or driving situation, such as hill, curve, winter, city, expressway.

The allocation of the characterization of environmental influences to the architecture takes place in the light of FIG. 13.

The driver type recognition, driving situation recognition and vehicle variables are assigned to information suppliers ED, DD, Ud and VD in the uppermost plane, and are therefore visible to all the other components, and drive train state variables pd (powertrain data) are ascertained in the powertrain, and may also therefore be used directly only within the powertrain.

The 2nd step establishes based on what it is that the entire following method is to be optimized. Criteria are conceivable, for instance, such as sporty driving manner, economical driving method or especially a wear-preventive driving manner. The advantage of the global establishment lies in the subsequent uniform use in all decisive functions, from the acceleratot interpretation to engine torque selection and transmission ratio selection.

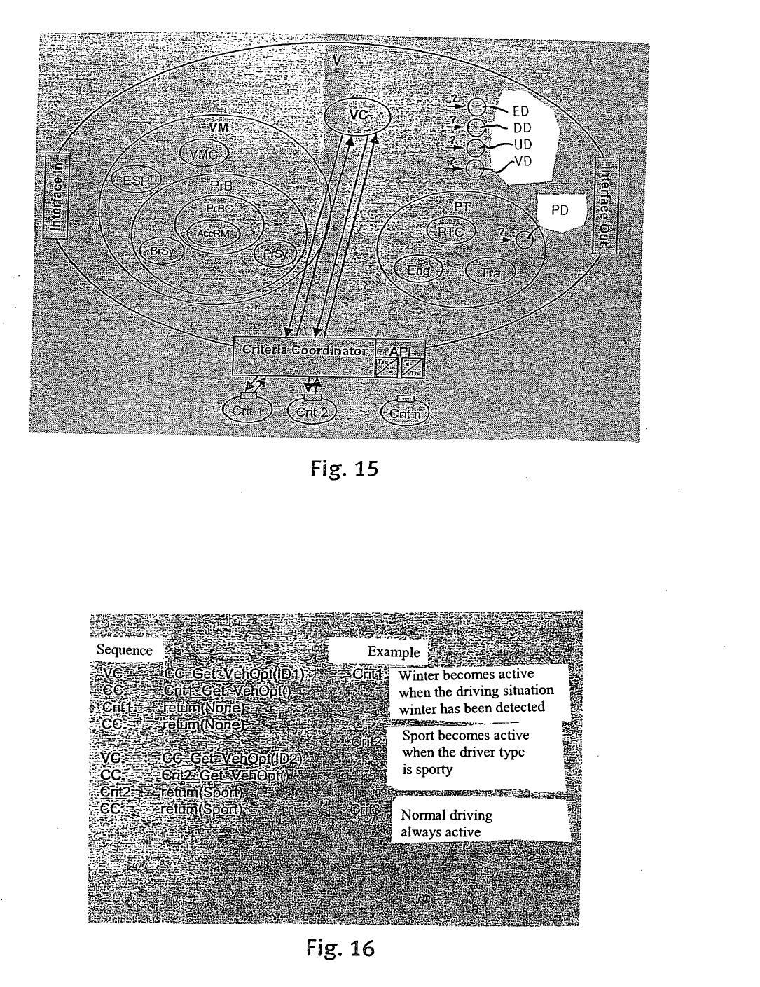

According to FIG. 15, the selection of the current optimization criterion is controlled by the vehicle coordinator, VC. It polls suggestions of plug-ins (Crit x), via a special interface, of the criteria coordinator, CC, and prioritizes these only. How the plug-ins handle the task of ascertaining a suggestion, and what type of plug-in is involved in each case, is not known to the vehicle coordinator in this context.

FIG. 16 shows an exemplary prioritization sequence corresponding to FIG. 15, for the selection of the optimization criterion by the vehicle coordinator.

The sequence shown in exemplary fashion on the left side of FIG. 16 starts from plug-ins, as shown as an example on the right side.

In this example, there are, in the order of their importance, the three plug-ins “winter”, “sport” and “normal travel”. Except for normal travel, these have the property that they make a suggestion on the optimization criterion only (in other words, they are only “active”) if a certain situation is at hand, and if it is not at hand, they make no suggestion (that is, they are “inactive”). Normal travel is an exception in this respect, since it is always active, without a certain condition being at hand.

The sequence is described as follows: Before the colon, all the way on the left, there is the object that triggers an activity and calls up another object. After the colon, on the right, there is the method of the called-up object.

The vehicle coordinator first calls up the criteria coordinator to have it poll a suggestion for a vehicle optimization from the plug-in having the ID 1. The criteria coordinator knows the plug-in named ID 1, and fetches from it the current optimization suggestion. However, since the driving situation winter in the example is not active, it returns none, that is, no suggestion.

The calling up of the next plug-in takes place in the same way, but it returns the optimization suggestion “sport”, since the driver type is “sporty”.

Now, since a suggestion for an optimization criterion has been found, subsequent plug-ins having a lower priority do not have to be polled any more for a suggestion.

The proposed prioritization method at this point is as simple as possible, namely, a fixed sequence is established and the highest ranked active criterion that does not reply “none” is the winner. One advantage of this prioritization is that all criteria do not always have to be polled for, since the procedure may be stopped at the moment an active criterion has been found.

As an interface between the vehicle coordinator and the plug-in (uniformly for all plug-ins) a fixed quantity of conditions is agreed upon. The desired meaning, such as “sport” or “wear” has to be known to both sides, since the vehicle coordinator is supposed to introduce corresponding measures (call-up Crit_Get_VehOpt( )).

The driver command interpretation as the 3rd step, according to FIG. 14, has the task of interpreting the specifications of the driver and to derive therefrom a specification for the longitudinal motion of the vehicle. Besides the pure accelerator interpretation, this includes, for instance, also the specifications of a speed regulator or an ACC, which carry out the command of the driver for automatic travel at constant speed. Transmission output torque and vehicle deceleration are provided as interface to the powertrain and the brakes.

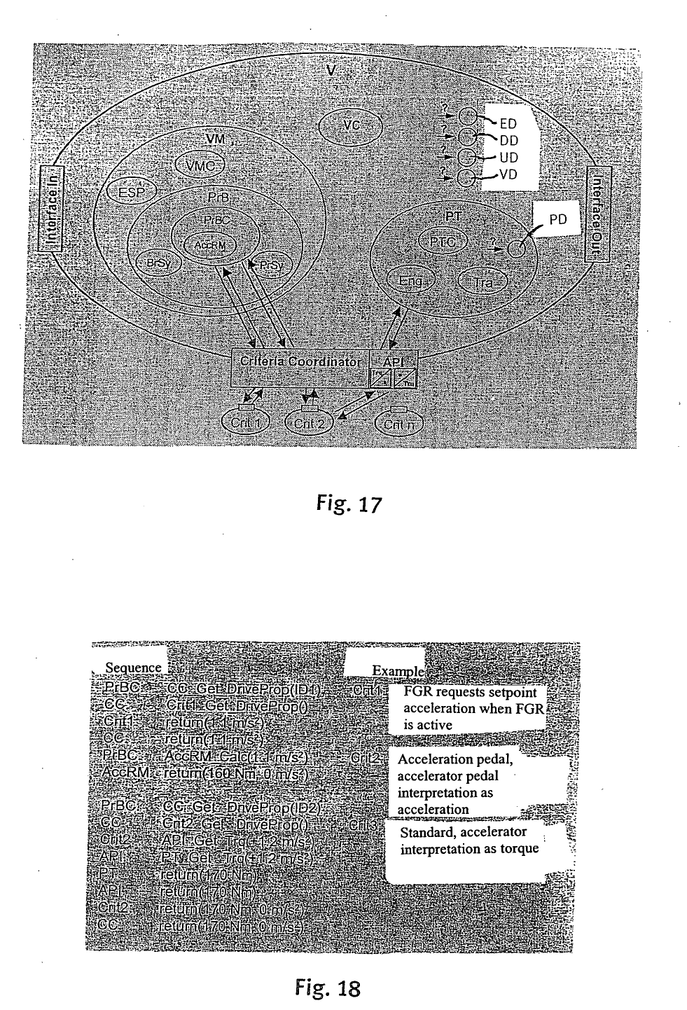

The sequence of the driver command interpretation according to FIG. 17 controls the propulsion and brakes coordinator, PrBC. The latter, in cooperation with an undetermined number of plug-ins, according to a special prioritization method, ascertains the specifications for the brakes and the powertrain. The vehicle motion coordinator, VMC, coordinates these slow specifications with the rapid interventions of the traction system and vehicle stability system (ESP) (the concepts slow and rapid are supposed to indicate here that the reaction times of a normal driver are “long”, compared to the reaction times of an electronic system), and routes the demands thus obtained on to the drive train (propulsion system, PrSy and the brake system, BrSy, the further evaluation and execution of the specifications to the brakes not being a part of this representation.

The criteria coordinator offers still another special interface (application programming interface, API) for recalculating a vehicle acceleration into transmission output torque that is required at the current point in time, and vice versa, the criteria coordinator itself not fulfilling this task, but, for example, routing it on to the drive train, since the latter anyway includes the relatively costly recalculation for mastering its tasks. Thereby advantages accrue in the application of the plug-ins:
the plug-ins become simpler, clearer and smaller,
the plug-ins become independent of vehicle-specific data and
the overall software volume becomes less.

FIG. 18 shows an exemplary prioritization sequence analogous to FIG. 16 according to FIG. 17, for driver command interpretation.

The exemplary sequence for driver command interpretation in FIG. 18 is oriented to the plug-in vehicle speed regulator (FGR), the accelerator pedal and the “standard” accelerator having the following functionalities:

If the driver has activated it, the vehicle speed regulator tries to regulate a fixed speed by requesting a setpoint acceleration. The accelerator pedal interprets the gas pedal setting by the driver as an acceleration command. The standard gas pedal interprets the gas pedal setting by the driver in a speed-dependent manner as transmission output torque.

Via the criteria coordinator, the propulsion and brake coordinator first asks the plug-in having the ID 1 (vehicle speed regulator) for its propulsion command. It supplies a command for an acceleration of 1.1 m/sec². The demand the PrBC is able to route outwards, however, is the transmission output torque and the braking deceleration. Therefore it instructs the acceleration request manager, AccRM, to carry out a standard subdivision of the demanded acceleration into propulsion and brakes. This gives a transmission output torque of 160 Nm and no deceleration.

Subsequently, the plug-in having ID 2 is called up. The accelerator pedal ascertains a desired acceleration of 1.2 m/s² because of the driver specification at the accelerator. However, this plug-in takes care of the subdivision into propulsion and brakes by itself, via the API of the criteria coordinator, and gives a propulsion demand of 170 Nm and no deceleration back to the coordinator.

The third plug-in standard accelerator is not called up. In the previous step (establishing the optimization criteria), sport was established as the current optimization criterion. In the case of this optimization criterion, in the driver command interpretation, instead of the standard accelerator, in this example the acceleration pedal is called up, and the standard pedal is not needed.

In conclusion, the coordinator selects the plug-in having ID 2 as the winner, since its demand had the highest amount. In addition, it communicates to all the plug-ins that the plug-in having ID 2 has won with a demand of 170 Nm of transmission output torque and no deceleration. From this, the vehicle speed regulator is able to recognize that its suggestion has been overruled by another plug-in, and can act accordingly (e.g. holding onto the 1-share or deactivation).

The prioritization of the driver command interpretation is a broadening of the linear method: From the quantity of all plug-ins that are able to make a suggestion for driver command interpretation, only those are selected whose suggestion fits the current optimization criterion. Thus, for example, depending on the optimization, a normal accelerator pedal may be exchanged for a sporty accelerator pedal. Subsequently, a linear prioritization takes place of all those plug-ins for which a fixed ranking sequence can be established. This may be done, for instance, for a brake pedal, since during the operation of the brake, FGR and accelerator pedal have to be inactive (to be sure, only conditionally, see board test). If a plug-in becomes active in this phase, the method breaks off, corresponding to the linear prioritization.

If, however, no plug-in is active, all further plug-ins, that are not able to be ordered into a fixed ranking sequence, are called up. The prioritization then takes place, from the quantity of all suggestions, by a maximum selection.

Basically, with this procedure, only those criteria are drawn upon that fit the current optimization criterion; the actual prioritization takes place in a two-step method:

In a first (applicable) table, a sequence is established for the criteria according to which they are polled. The moment a command is recognized, the method breaks off. For some criteria this simple prioritization is sufficient (e.g. in the case of a request by a brake pedal, FGR and accelerator pedal, no further polling needs to be done.

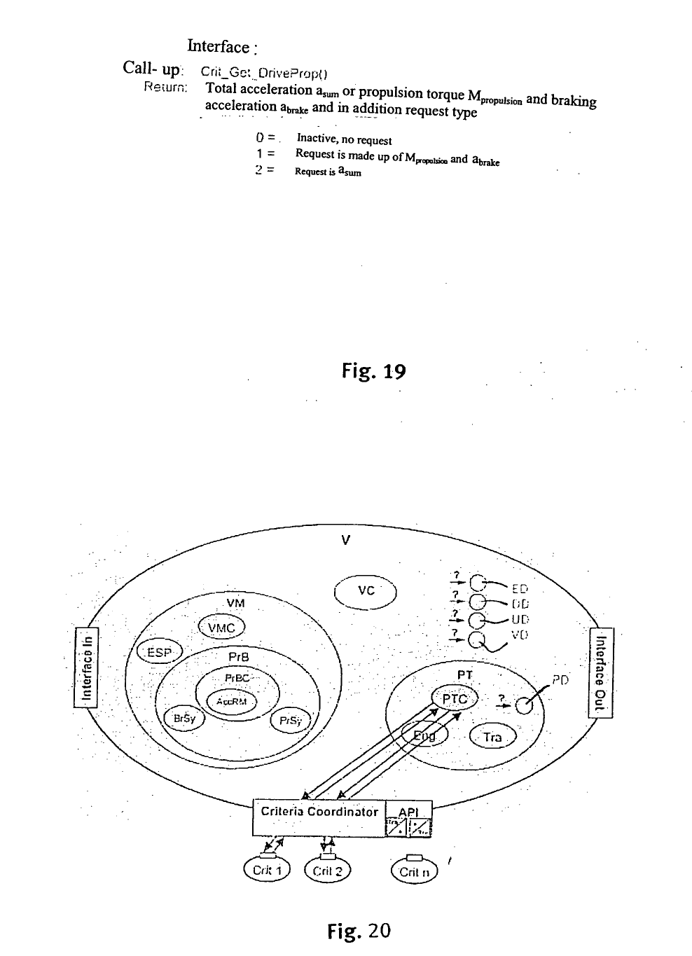

In case no command can be ascertained in the first step, in a second step a maximum selection of the propulsion torque command is carried out of all requesters registered in a second (also applicable) table; provided there is at least one negative torque command, the smallest negative command is selected, and otherwise the largest positive torque command is selected. FIG. 19 shows an exemplary request of a plug-in.

As an interface, in contrast to the propulsion coordinator and the brake coordinator, two alternatives are available to the plug-ins. They may either request transmission output torque Mₚᵣₒₚᵤₗₛᵢₒₙ and braking deceleration a_{brake}, or a summation acceleration aₛᵤₘ. If a summation acceleration is requested by a plug-in, the coordinator may itself decide how it wants to subdivide this to propulsion and brake (using the acceleration coordinator).

In order, on the one hand, to make easier the recognition of a non-present propulsion command (plug-in is inactive), (0 Nm is a definite propulsion command, and is therefore not suitable for characterizing of “no command”), and on the other hand, to indicate the interface alternative used, the plug-in additionally specifies the request type 0.1 or 2.

The driver command interpretation supplies as a result a transmission output torque that is to be made available by the powertrain (the required auxiliary component power would still be added to this). For this, there now has to be determined an optimum operating point as the 4th step according to FIG. 14, it being oriented optimally to the selected optimizing criterion. An operating point comes about in a conventional powertrain from the engine torque and the transmission ratio of the transmission, because the rotary engine speed, at a given vehicle speed, may be directly calculated from it. For future concepts, by installing further assemblies, there may perhaps come about additional degrees of freedom (e.g. an e-machine in 4-quadrant operation).

The determination of the optimal operating point according to FIG. 20 is administered by the powertrain coordinator, PTC. It communicates in the usual way with the plug-ins, via the criteria coordinator.

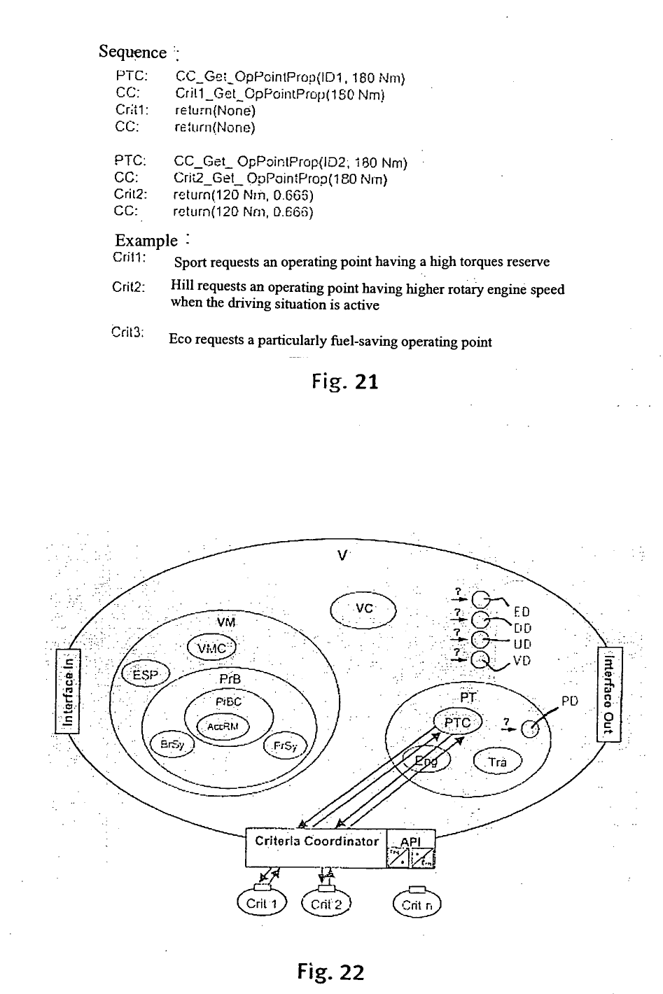

FIG. 21 shows an exemplary prioritization sequence analogous to FIG. 16 according to FIG. 20, for determining the optimal operating point.

The sequence for determining the optimal operating point takes place again according to the scheme of the linear prioritization. As an example, three plug-ins are shown, having the tasks sport, hill and economical.

The powertrain coordinator calls up the criteria coordinator, to poll for a suggestion for an optimal operating point at a propulsion torque of 180 Nm from the plug-in having ID 1. The criteria coordinator knows the plug-in named ID 1, and fetches from it the optimal operating point. Since driving situation sport is not active, it returns none, that is, no suggestion. Calling up the next plug-in having ID 2 takes place in the same way, and this indicates an optimal operating point having an engine output torque of 170 Nm and a transmission ratio of 0.666.

For the prioritization only those criteria are drawn upon that fit the current optimization criterion (an applicable table with all “fitting” criteria for each optimization criterion). For the criteria, a sequence is established according to which they are polled (see FIG. 21). The criterion having the highest priority is polled first. If it is not active, the next one is polled, etc, until the first active criterion is found, and after that the method breaks off.

The first active citerion is used. At the interface, consequently, the following takes place:

Call-Up: Crit_Get_OpPointProp (transmission output torque)

Return: engine output torque, transmission ratio.

The plug-ins are called up, the setpoint transmission output torque being transferred to them as parameters, so that the plug-ins know, according to their task, which torque demand an optimal suggestion is being polled for.

The last task of the coordinated powertrain control is the approach to the optimum operating point as the 5th step, according to FIG. 14. The current and the new optimum operating point may, under certain circumstances, lie relatively far “apart” (e.g. when the driver suddenly steps on the accelerator). In order to assure driveability, comfort, safety and assembly protection it is therefore frequently sensible not to permit any abrupt transition (as quickly as possible), but to approach the new operating point in damped fashion.

The approach to the optimal operating point according to FIG. 22 is administered in common with the determination of the optimal operating point by the powertrain coordinator, PTC. It communicates in the usual way with the plug-ins, via the criteria coordinator.

The finally ascertained result is routed from the powertrain coordinator to the components engine and transmission for execution.

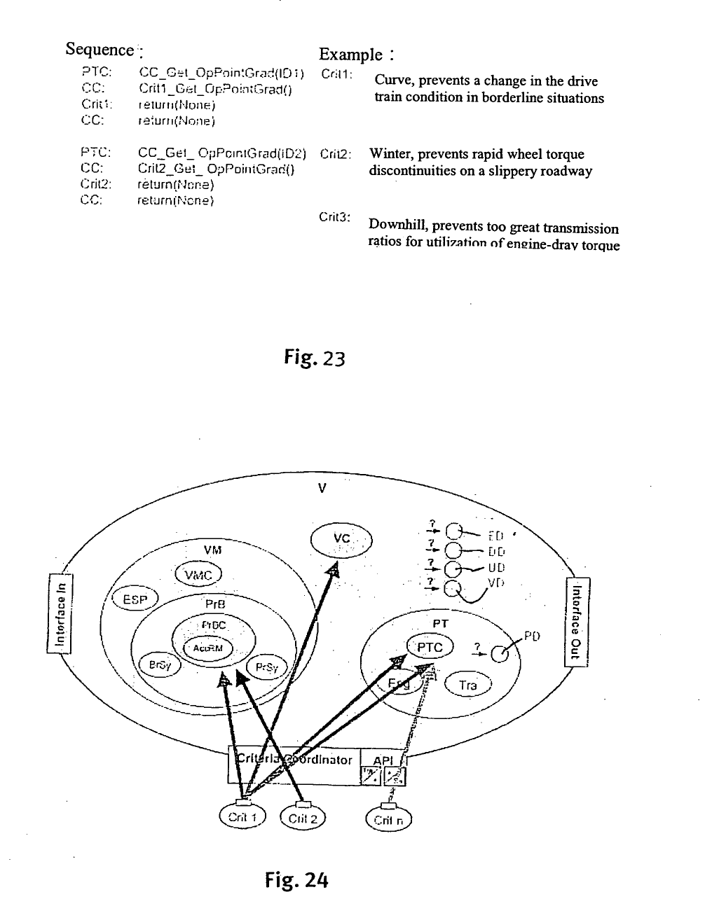

FIG. 23 shows an exemplary prioritization sequence analogous to FIG. 16 according to FIG. 22, for approaching the optimal operating point.

The sequence for approaching the optimal operating point is based again on the linear prioritization method. As an example, the plug-ins curve, winter and hill are shown.

The powertrain coordinator calls up the criteria coordinator to have it poll a suggestion for a gradient limitation of the plug-ins having ID 1.

The criteria coordinator knows the plug-in named ID 1, and fetches from it a gradient limitation. Since Crit 1 is not active (curve, prevents a change in the drive train condition in driving dynamic limit situations), it replies “none”, that is, no suggestion.

The call-up of the next plug-in having ID 2 takes place in the same manner, and replies “none”, that is, no suggestion, since Crit 2 (winter) is also not active.

For the prioritization only those criteria are drawn upon that fit the current optimization criterion of the operating point ascertainment (an applicable table or list having all “fitting” criteria for each operating point criterion).

For the criteria, a sequence is established according to which they are polled (see FIG. 23). The criterion having the highest priority is polled first. If it is not active, the next one is polled, etc, until the first active criterion is found, and after that the method breaks off.

(An additional possibility arises in that a max or min selection is carried out from all requests).

At the interface, the following takes place:

Call-Up: Crit_Get_OpPointGrad( )

Return: Gradient limitation, e.g. in the form of filter parameters, min and max values for engine torque adjustment and transmission ratio adjustment.

The prioritization method for approaching the optimal operating point differs from the linear prioritization method in that there does not have to be one plug-in that also actually makes a suggestion, all plug-ins may reply “none”, which is then interpreted as approaching “as rapidly as possible” the new operating point.

The interface for the specifications of the plug-ins may turn out to be quite multifarious. What comes to mind is gradient limitations, filter parameters or absolute limits for engine torque and transmission ratio.

FIG. 24 shows generally a schematicized structuring according to FIG. 13 in the use of individual plug-ins by various interfaces.

Corresponding to the assigned tasks, individual plug-ins may use one, several or all interfaces. The following exemplary plug-ins sport, crawling and curve thus use different interfaces.
Sport:
   request sporty vehicle optimization,
   request sporty accelerator pedal interpretation by another pedal characteristics curve and less abrupt load alteration damping,
   request sporty transmission ratio choice having great torque reserve because of higher rotary speed,
   request sporty transmission ratio adjustment (rapid instead of comfortable for as great an acceleration as possible);
Crawling
   changed accelerator pedal interpretation having braking intervention, in order to make possible parking as simply as possible;
Curve
   preventing transmission ratio adjustments during cornering in the borderline range.

Finally, the advantages of the entire invention are recited once more in summary:
A function in the sense of a coherent functionality, recognizable by the driver, frequently has requests and effects upon the most varied components in the vehicle. For instance, an adaptive speed regulator is able to accelerate and decelerate while maintaining a speed specified by the driver. To do this, the components engine, transmission and brakes must be controlled accordingly. This is made possible in the system described, without the functionality having to be subdivided to various components. The functionality remains together as a unit, and may be added to or taken from the system without having to change the software or hardware of the system to do this.
Into this optimized system, requests of various systems may then be centrally introduced in a uniform manner, based on system reference variables (essentially the transmission output torque).
Into this optimized system, the most varied methods for ascertaining suitable operating points of the powertrain may be introduced.
In this optimized system, the requests and the methods may be prioritized, corresponding to the current driving situation by an abstract prioritization method, according to the situation, so that the “correct” request is taken into consideration and the “optimal” method is used for the operating point selection,
This optimized system recalculates the requirements corresponding to the drive train topology of the respective vehicle, and makes specifications on drive train components, the interfaces to the components being established as abstractly as possible on a physical basis, in order to exclude as far as possible dependencies, for instance, on various engine types (Diesel and gasoline).
This system offers the possibility of combining the ascertainment of requests and methods for calculating optimal operating points in plug-ins, in order thus to create separable systems in the sense of salable products.
A function in the sense of a coherent functionality that is recognizable by the driver frequently has requirements and effects on the most varied components in the vehicle. For example, an adaptive speed regulator is able to accelerate and decelerate when maintaining a speed specified by the driver. To do this, the components engine, transmission and brakes must be controlled accordingly. This is made possible in the system described, without the functionality having to be distributed to various components. The functionality remains together as a unit, and may be added to or taken from the system without having to change the program of the system to do this.
The prioritization methods for the evaluation of the requests of various plug-ins may, based on their uniformity (all plug-ins request a transmission output torque (the reference variable of the system) for the acceleration of the vehicle), be designed in such a way that it does not have to be known, for the prioritization, which system is behind the request (from the point of view of the prioritization method it makes no difference which functionality a plug-in fulfills, but only what priority it has). By this anonymization of the requesters, it is possible freely to choose the number of plug-ins that are to be considered, without having to change the program to do it. Thereby the configuration of the system becomes substantially simpler for adaptation to a certain vehicle variant and functional variant, and functions may still be added retroactively that were not planned for originally.
For the components in the drive train, uniform abstract interfaces are created which to the greatest extent are independent of variants of the components. Because of this, while maintaining the interfaces, components from different manufacturers may very simply be installed, whereby the vehicle manufacturer does not make himself dependent on the proprietary solutions of individual suppliers.
The programs of the plug-ins may to the greatest extent be specified without knowledge of the kind of components used, and may therefore be reused in many vehicle configurations. Considering the large number of vehicle variants, this is a clear advantage. A typical example is the vehicle speed controller, which differs internally a great deal depending on whether a Diesel or a gasoline engine is propelling the car. The system described acts like an interediate layer, which decouples the functionalities, that are portrayed in the plug-ins, from the components. An additional positive effect of the decoupling is the reduction in the application expenditure which is otherwise frequently generated by changes in other functions or components.

1. A computer system comprising at least one processor and at least one memory for controlling, especially for coordinating powertrain control for a motor vehicle, having a software architecture that has essentially the following elements or components:
an operation system and specific services having an operating system and specific services as the basis for all other elements and applications,
a basic functionality for carrying out universal requests,
a layer for coordinating tasks for basic functionalities of the base functionality and for linking in plug-ins,
at least one plug-in for carrying out practical tasks or functions which go beyond the basic functionality and are coordinated by the layer, the plug-ins being especially modularly exchangeable.

2-33. (canceled)
